(19) United States
(12) Patent Application Publication
(10) Pub. No.: US 2009/0047481 A1
(43) Pub. Date: Feb. 19, 2009

(54) Garments having a curable polymer thereon and a system and method for its manufacture

(75) Inventors: David Welsch, Livingston, NJ (US); Anthony Angelino, Edmond, OK (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Cupid Foundations, Inc., New York, NY (US)

(21) Appl. No.: 12/228,259

(22) Filed: Aug. 11, 2008

Related U.S. Application Data
(60) Provisional application No. 60/964,755, filed on Aug. 15, 2007.
(60) Provisional application No. 61/063,106, filed on Jan. 31, 2008.

(51) Int. Cl. D06C 25/00; B32B 3/02; B32B 33/00; A41D 1/00; A41F 15/00; A41C 3/10; D06C 3/00

(52) U.S. Cl. 428/179; 427/285; 118/708; 118/711; 118/680; 118/681; 442/104; 442/153; 428/195.1; 428/192; 450/41; 2/69; 2/338

(57) ABSTRACT

A method and system for garment manufacture fixes a curable polymer in either a continuous bead or in a non-continuous or segmented bead onto a cut fabric piece. The cut fabric piece, the continuous bead and the non-continuous, segmented bead have a wide array of configurations. If the cut fabric piece has a contoured edge region, a silicone bead proximate that edge has a conforming configuration. In the method, the cut fabric piece is placed in a coordinate space. The location of the cut fabric piece is sensed and that information is used to control the movement of a curable polymer dispenser. The dispenser applies a curable polymer from the curable polymer dispenser onto the cut fabric piece in the desired configuration after which the polymer is cured. If the fabric is cotton, the curable polymer is drawn into the cotton fibers prior to cure. The flow of curable polymer from the dispensing head can be started and stopped as the dispensing head moves relative to the fabric, allowing the curable polymer to be deposited on the fabric in any configuration.

### CROSS-REFERENCE TO RELATED APPLICATIONS

This application claims the benefit of the filing date of U.S. Provisional Patent Applications No. 60/964,755 filed Aug. 15, 2007, and 61/063,106 filed Jan. 31, 2008, the disclosures of which are hereby incorporated herein by reference.

### BACKGROUND OF THE INVENTION

The present invention relates generally to fabrics having a non-linear perimeter with curable polymer deposited thereon that has a non-linear trajectory and a method and system for depositing curable polymers onto fabrics and, in particular, fabrics that have a non-linear perimeter.

The use of a polymer such as silicone to finish the edges of a fabric and to provide a polymer bead to ensure that the garment remains properly placed on the wearer is described in U.S. Pat. No. 7,228,809, filed on Apr. 15, 2004 and entitled “Undergarments Having Finished Edges and Methods Therefor” which is hereby incorporated by reference. U.S. Pat. No. 7,228,809 is commonly assigned with the present application.

The application of polymers onto fabrics clearly provides manufacturing and performance advantages at both the fabric edge region and on interior regions of the fabric. The advantages have not been completely exploited however, due to the difficulty of precisely placing the polymer on the fabric in targeted locations and custom (e.g. nonlinear) configurations. Deployment of the solution for many different locations in a garment with a scooped contour (e.g. neckline, underarms) has been limited due to these difficulties. Accordingly, a method for depositing a polymer on a fabric in a variable or custom configuration is still sought.

### SUMMARY OF THE INVENTION

The present invention contemplates a garment with a cured polymer deposited thereon and methods and systems for depositing cured polymers onto fabrics. In certain embodiments, the cured polymer, as deposited and cured on the garment, has what is referred to herein as a “non-linear” or “contoured” trajectory. In the context of the present invention, these terms mean that the line of the cured polymer, as deposited, varies in both the y and x directions for at least some portion of its trajectory. Preferably the non-linear trajectory forms a gradual or smooth curve and not an abrupt change in the y direction with respect to the x direction, although such abrupt changes are not precluded. Typically, the garment is formed from one or more panels of fabric which are joined together to form the garment. The panels are cut from larger bolts of fabric in a particular configuration. The configuration of the fabric can be square or rectangular, but often the fabric panel has one or more sides with a non-linear or contoured perimeter. One example of a contoured perimeter is a cut out for a scooped neckline, holes for arms and legs, bra wing etc.

These contoured perimeters are often in portions of the garment where a scoop or other such contour is required or desired for garment fit. Specifically, panels with such contours are often found in the neckline portions of garments. One very specific example of a panel with a contoured perimeter is the portion of a bra known as a bra wing. The bra wing panel, illustrated in FIG. 1, has a contour perimeter to fit under and otherwise conform to the underarm of the wearer. As described herein, it is regarded as advantageous for these portions of the garment to have an edge region or interior region with a curable polymer formed thereon for the garment to have a “non-slipping” relationship with the wearer. In addition, fabric panels with the cured polymer disposed thereon have a smoother fit. In one embodiment, the cured polymer is silicone.

Advantageously, the cured polymer is formed on the garment in a non-linear trajectory that conforms to the contoured perimeter of a panel in the garment. In one embodiment, the cured polymer is a continuous silicone bead in the edge region of the garment. In a second embodiment, the cured polymer is a non-continuous or segmented silicone bead having the desired perimeter-conforming non-linear trajectory. In a third embodiment, the cured polymer is a series of parallel, non-continuous silicone beads. The silicone bead (either continuous or non-continuous) provides the desired non-slip characteristic for the wearer yet the non-continuous or segmented bead, as opposed to the continuous silicone bead, does not cause the wearer to sweat. Thus the presence of the cured silicone as a non-linear, non-continuous bead somewhat removed from the contoured perimeter of the garment is preferred but not required. The silicone bead on the edge region of the garment is preferably continuous in order to provide the garment with a somewhat finished edge.

One skilled in the art will appreciate that the present invention will have application in almost any portion of any garment. Examples of such garments include: foundation garments (e.g. bras, underwear, etc.); active wear (e.g. leotard, tights, cycling wear); and swimwear (e.g. swimsuits). As to portions of the garment where the present invention might be used, it is any portion where a non-linear application of cured polymer would be useful for comfort and fit. As previously stated, a fabric panel configured as a bra wing can have silicone in a non-linear trajectory that conforms to the underarm contoured perimeter of the bra wing. The bra wing fabric panel is subsequently incorporated into the bra. The fabric panel with the silicone so deposited finds an almost infinite variety of uses beyond bras and undergarments. One skilled in the art will appreciate that the panels can be incorporated into any garment where grip and smoothness are sought. Potential uses go beyond undergarments and active wear, and can include post-surgical compression garments that require some gripping to stay in place.

In certain preferred embodiments of the present invention, the method is deployed to provide a finished edge to a fabric having an irregular or contoured perimeter by disposing a curable polymer in the edge region of the fabric over, near or adjacent the perimeter of the fabric so that the curable polymer provides the characteristics of a finished edge (e.g. increased resistance to fraying or curling after repeated washing and wearing). The characteristics of a finished edge are not described in detail herein and are well known to one skilled in the art. The functional characteristics of a finished edge are described in previously identified U.S. Pat. No. 7,228,809. While the system and method disclosed herein are advantageous because they can be used to deposit the polymer in any location on the fabric and in any configuration, the claimed method is not limited in application to depositing the polymer exclusively at, near to, or adjacent irregular fabric perimeters, and can be used to deposit polymer in either a linear or non-linear configuration. Other embodiments of the present invention, such as those directed to the use of vacuum to draw the uncured polymer into the fabric for improved anchoring are not limited to applications in which the perimeter of the edge region of the fabric on which the curable polymer is deposited is irregular or contoured. These embodiments are useful in any application of curable polymer onto fabric, regardless of the shape of the fabric perimeter.

Typically, the fabric panel is a cut pattern piece having an edge region and an interior region of the fabric being adjacent the edge region. The fabric may include natural fibers such as cotton fibers or synthetic fibers such as nylon, polyester and spandex fibers. The fabric may stretch or may not stretch. The fabric panel preferably has at least one continuous bead of polymer (e.g. silicone) deposited in the edge region of the panel and one or more non-continuous beads of polymer in the interior region of the fabric. The polymer deposited on the fabric grips the wearer thereby holding the garment incorporating the cut pattern piece in place on a wearer's body.

While the dimensions of the continuous and non-continuous silicone beads are largely a matter of design choice, it is advantageous if the width of the continuous bead at, proximate, near to or otherwise adjacent to the perimeter of the fabric is not more than about 0.25 inches. In one example the range of widths of the continuous silicone bead is about 0.05 inches to about 0.25 inches. Specifically, this continuous bead provides the fabric with characteristics of a finished edge and does not perform a predominantly gripping function. The gripping function is performed by the non-continuous bead or beads. As previously noted the non-continuous bead, in some embodiments, is a series of approximately parallel beads. It is preferred if the width of the series of parallel beads is about 0.75 inches to about 2 inches, although this is exemplary. The number of individual non-continuous beads will depend upon the garment. However, for sufficient gripping a plurality of these non-continuous beads is preferred. Individual beads in the series of parallel beads have widths of about 1/16^{th} of an inch, but again, this width is by way of example and not limitation. The individual segments of the non-continuous beads can be any length, but smaller individual segments cause less sweating and numerous small segments provide a very good grip. In certain embodiments, vacuum is used to draw at least some of the curable polymer (e.g. silicone) beads into and among the fabric fibers upon deposition of the curable polymer onto the fabric.

The method desirably includes, after the disposing step, curing the polymer for binding the fibers in the edge region of the fabric to the cured polymer. In certain preferred embodiments, the fabric is cut into pattern pieces before the curable polymer material is disposed on the fabric. Each cut pattern piece may be incorporated into a garment with one or more other pieces of fabric. Methods for creating a garment from cut fabric pieces are well known in the art and are not described in detail herein. Sewing the garment from cut fabric pieces is conventional and well known to one skilled in the art. A method of forming a garment using adhesive seams is described in U.S. application Ser. No. 11/500,639 entitled “Adhesive Seam and Method and Apparatus for Its Manufacture” which was filed on Aug. 8, 2006 and is incorporated by reference herein.

As noted above, in certain preferred embodiments the curable polymer includes silicone. As is well known to those skilled in the art, a silicone is defined as any one of a large group of siloxanes that are stable over a wide range of temperatures. More specifically, silicones are any of a group of semi-inorganic polymers based on the structural unit R₂SiO, where R is an organic group, characterized by wide-ranging thermal stability, high lubricity, extreme water repellence and physiological inertness. Silicones are typically used in lubricants, adhesives, coatings, paints, synthetic rubber, electrical insulation and prosthetic replacements for body parts. In one particularly preferred embodiment, the silicone is a compound made up of, by weight, approximately 10-30% silica and 60-90% vinylpolydimethylsiloxane.

The method also desirably includes placing the cut pattern piece on a coordinate surface such as that described in U.S. Ser. No. 11/811,171 entitled “Method and System for Manufacturing Garments with Support Panels” which was filed on Jun. 7, 2007 and is incorporated by reference herein. The coordinate surface is used to control the position of one or more dispensing heads that are used to dispense the curable polymer on the surface of one or more fabrics disposed on the coordinate surface. The one or more dispensing heads are used to deposit a bead of the curable polymer along the fabric perimeter as desired or to deposit beads of curable polymer tread in a desired pattern on the fabric. The uses of the curable polymer tread in a garment are described in detail herein.

It is advantageous if a protective material is placed over the coordinate surface to protect the surface from excess curable polymer during deposition. This protective material at least partially absorbs the uncured polymer. Preferably the protective material is highly disposable. Toilet tissue is one example of a suitably absorbent, suitably disposable material. In a preferred embodiment, vacuum is applied to the fabric as the curable polymer is deposited thereon. This draws the curable polymer into the fabric and excess curable polymer into the vacuum system. The vacuum system can therefore be used in cooperation with the protective material or as an alternative to the protective material.

After the uncured polymer has been deposited on the cut pattern piece, the polymer is desirably cured using heat. In one preferred embodiment, one or more heating stations are provided for curing the polymer. The cut pattern piece may be placed in proximity with the one or more heating elements to effect cure of the polymer. In one preferred embodiment, the cut pattern piece may be introduced into the heating station on a conveyor element, such as a conveyor belt. The conveyer is adjacent the surface with the absorbent material thereon on which the fabric is positioned for polymer deposition to accomplish transfer from the polymer deposition station to the heating station.

The heating station may have one or more heating elements for generating heat. The temperature of the polymer and/or the temperature of the cut pattern pieces may be monitored to insure that the polymer is heated to an adequate temperature to properly cure the polymer. In certain preferred embodiments, the polymer is heated to approximately 260-280 degrees Fahrenheit. In more preferred embodiments, the polymer is heated to approximately 265-275 degrees Fahrenheit. The time limit for heating the polymer may vary. In one preferred embodiment, heating for about one minute cures the polymer on the cut pattern piece. One skilled in the art will appreciate that the heating station and heating conditions will depend upon the curing conditions required for the particular curable polymer, the fabric on which the curable polymer is deposited, the dwell time in the heating station tolerated by production requirements and a number of other factors. One skilled in the art can design a heating station with these considerations in mind.

In one preferred embodiment, the conveyor element cooperates with the coordinate surface to convey the cut pattern pieces to and from the coordinate surface. The conveyor element may include a conveyor belt having a top surface for supporting the cut pattern pieces as the pieces move between various stations, i.e. cutting station, distribution station, disposing polymer station, curing station, etc. In one particular preferred embodiment, the top surface of the conveyor belt may include a material having a low coefficient of friction or a non-stick material such as the material sold under the trademark TEFLON. As a result, there may be no need to provide an absorbent material between the pattern pieces and the conveyor because any polymer deposited on the conveyor may be easily removed from the top surface such as by using a scraper.

The step of disposing a curable polymer on the cut pattern piece may include disposing a first continuous polymer bead over, adjacent, near or proximate to the perimeter of the pattern piece and disposing at least one second non-continuous or segmented polymer bead adjacent the first polymer bead. The at least one second polymer bead may be narrower in width than the first polymer bead. In more preferred embodiments, the at least one non-continuous polymer bead includes a plurality of non-continuous polymer beads. The beads, whether continuous or non-continuous, conform to the contoured perimeter of the cut pattern piece. The at least one non-continuous polymer bead may include a plurality of non-continuous polymer beads spaced from one another, with the fabric of the pattern piece exposed between the plurality of non-continuous polymer beads. The one or more second polymer beads may extend in a direction parallel to the perimeter of the fabric or may extend along a path that otherwise conforms to the contoured perimeter of the fabric.

In other preferred embodiments, the polymer may be provided on the interior region of the pattern piece (i.e. not the edge region of the fabric). In these embodiments, the cured polymer may provide gripping to prevent the fabric from riding or slipping over the body of a garment wearer. The cured polymer may be one or more beads that follow an S-shaped or curved pattern. The one or more polymer beads may be continuous or non-continuous. The curable polymer may also be deposited as polymeric dots on the fabric. The intermittent polymer deposits may form a matrix of polymer on a fabric. In certain preferred embodiments, the spacing between the polymer beads may be increased for increasing the stretchability of the fabric. In other preferred embodiments, the spacing between the polymer beads may be decreased for increasing the gripping of the fabric. The polymer beads may also be applied over a central region of a fabric to provide gripping at the central region for holding the fabric in place when worn. This provides a garment having stability due to the gripping from the polymer. This stability minimizes the likelihood that the fabric will roll over upon itself, which may result in bunching or binding of the garment. The present invention also provides a finished edge that has more stretch because it does not have a thick finished edge that is formed when using narrow elastic, trim, lace and/or a folded-over edge.

Regardless of whether the curable polymer is dispensed at or near the perimeter of the fabric in the edge region or in the interior region of the fabric, it is advantageous if the curable polymer is dispensed in a way that provides a consistent bead size. This is particularly difficult at the perimeter of the fabric along the direction in which the beads are dispensed and along any curves in the fabric to which the curable polymer bead conforms.

It is advantageous if the curable polymer dispensing head (whether configured to deposit the curable polymer along a contoured perimeter or a straight perimeter in the edge region or in an interior region of the fabric) is brought into contact with the fabric at the conclusion of bead deposition. This avoids curable polymer icicles from forming on the dispensing head after the flow of curable polymer is stopped when bead deposition is complete. A build up of silicone on the dispensing head can cause curable polymer to be deposited in an undesired location, at best causing an unnecessary mess and at worst ruining one or more pieces of fabric. In order to avoid the formation of curable polymer residue on the head, the following sequence is practiced. First, the pressure in the dispensing head is turned off to stop curable polymer from flowing. Then after a brief moment, (e.g. about one second or less) the dispensing head is brought into contact with the underlying fabric.

With regard to curves, it is advantageous if the flow rate of the curable polymer from the dispensing head is adjusted if the dispensing head is required to rotate in order for the deposited curable polymer bead to conform to the curve. Without a flow adjustment, there will be a variation in bead thickness at the curve, which is not preferred. The change in flow rate will depend upon a number of factors that are specific for a particular dispensing head. Whether the flow rate increases or decreases will depend upon whether the dispensing head accelerates or decelerates in response to the rotation. If the dispensing head accelerates, the flow rate of the curable polymer will be increased. Commensurately, if the rotation causes the dispensing head to decelerate, then the flow rate of the curable polymer from the dispensing head will be decreased. Preferably, the flow rate of the curable polymer is adjusted by adjusting the pressure under which the curable polymer is delivered to the dispensing head. However, other mechanisms for adjusting the flow rate (e.g. control valves, flow regulators) are also contemplated.

In still another preferred embodiment of the present invention, a method of controlling a stretchable garment utilizing the stretch characteristics of stretchable fabric includes providing a spread of stretchable fabric that has the same stretch in two axial directions or is more stretchable in a first axial direction and less stretchable in a second axial direction. A pattern piece is cut from the spread, wherein the cut pattern piece has unfinished edges with free ends of fibers at the unfinished edges. The method desirably includes disposing a curable polymer near the perimeter over one of the unfinished edge regions of the cut pattern pieces. Preferably, the curable polymer is located sufficiently at or near the edge to engage fibers that terminate in free ends at the perimeter. It is desirable for one of the edge regions having the curable polymer disposed thereon to extend along a third axial direction that crosses the first axial direction, and after the disposing step, curing the polymer to finish the edge of the fabric. Depositing the curable polymer in this manner restricts the stretch in the vicinity of the silicone. Strategic deposition can be used to impart customized stretch to the fabric.

In addition to silicone, other curable polymer materials that cure using mechanisms other than a thermal cure (e.g., ultraviolet radiation cure) are also contemplated as suitable for use in the present invention. Again, the requirements are suitable adhesion to fabric and maintaining adhesion and flexibility over time when subjected to repeated wear and washing.

Although the curable polymer, when introduced into contact with the fabric, wets the surface of the fabric somewhat, the amount of curable polymer, the thickness of the curable polymer and its viscosity are selected to ensure that the curable polymer does not significantly permeate through the thickness of the fabric. For example, if silicone beads are placed in the interior of a garment to allow the garment to grip the wearer, it is preferred if such beads do not show through the fabric.

In order to facilitate precision placement of the curable polymer on the garment panel, a control system is required that can sense the placement of the fabric relative to a reference position on the coordinate surface. A camera or laser in cooperation with software that contains information about the size and configuration of the panel is used for this purpose. Specifically, a camera or one or more lasers are used to sense the position of the fabric panels in the coordinate space. The control software, which is programmed with the size and configuration of the fabric panels (input by the user), controls the movement of the curable polymer dispenser to dispense the curable polymer on the fabric panel. Because the invention requires that the control system sense the location of the fabric with precision to facilitate targeted placement of the uncured polymer thereon, the system employs a retention mechanism for keeping the fabric panels in place on the coordinate surface. In one example, vacuum suction on the backside of the coordinate surface is used to retain the fabric on the coordinate surface.

The curable polymer dispenser is operably connected to a moveable arm which moves the dispenser relative to the coordinate surface. A controller is provided for this purpose. The controller is able to sense and control the movement of the moveable arm in the context of the coordinate space. In one embodiment, servo motors or stepper motors in conjunction with a linear slide axis are provided for this purpose.

The coordinate surface is a reference surface. The surface coordinates correspond to coordinates programmed into the controller. An operator (or controller if the system is automated using software (e.g. Win/CNC Software which is commercially available from Microsystems of Buckhannon Inc. of Buckhannon W. Va.)) references the surface coordinates to precisely place both the panel and the body fabric on the coordinate surface. The controller controls the movement of the moveable arm relative to the coordinate surface based upon information available to the controller regarding fabric shape/configuration relative to the coordinate surface. The coordinates of the predetermined region of the fabric panel (e.g., the region of the fabric panel proximate to the perimeter) is provided to the operator, the controller, or both, depending upon the extent of system automation. The controller selects coordinates for the moveable arm that corresponds to the coordinates for the fabric in the coordinate space. The controller then places the moveable arm and, by extension, the dispenser, proximate to the predetermined region. The controller then causes curable polymer to dispense from the dispenser as the controller controls the movement of the moveable arm relative to the fabric.

Advantageously, the system provides precision control of the application of the curable polymer on the cut fabric piece. The controller is programmable so that, for a given fabric configuration, the moveable arm is controlled to dispense curable polymer onto the fabric that conforms to the fabric configuration. The controller is programmable to make this determination based upon the coordinates of the fabric provided to the controller by the operator, camera sensor, or laser sensors. Specifically, the controller has an embedded algorithm, or is operably connected to a CPU or other component with digital processing capability. Based upon the input to the CPU, an algorithm, either in hardware or software, which is programmed to identify a region and orientation on which the curable polymer is to be placed based on fabric dimensions and other input (there may be a menu of options for the operator to select such as “finish only,” “tread only,” “finish and tread” etc.), outputs instructions to the controller. The controller then controls the movement of the moveable arm to dispense the curable polymer on the fabric in the desired location and configuration. In a preferred embodiment, the dimensions of the fabric panel are stored in memory. The coordinates of the curable polymer placement on the fabric panel are also stored in memory. When the system images the fabric panel, the actual dimensions of the fabric panel are compared with the dimensions stored in memory. If the dimensions are different, the system adjusts the coordinates of the curable polymer placement to conform to the actual dimensions of the fabric panel. The system can also be programmed to discard a fabric panel if the position of the fabric panel relative to the curable polymer dispenser is not within a certain tolerance. The tolerance is a matter of design choice and depends primarily upon the range of movement provided to the curable polymer dispenser. The goal is to accurately dispense the curable polymer onto the fabric panel. In one embodiment, the fabric panel is discarded if the actual position of the panel differs by more than fifteen percent (15%) from the preset position of the fabric panel relative to the curable polymer dispenser. The position of the fabric panel is determined using a sensor such as a camera, which can detect the position of the fabric panel relative to the coordinate surface.

The present invention is also directed to a novel bra wing. The bra wing has a contoured perimeter to form around the arm and shoulder of the wearer. The bra wing has a first bead portion and a second bead portion. In the first bead portion the one or more beads conforms to the contoured perimeter. In the second bead portion the beads do not conform to the contour edge, but follow some trajectory on the interior region of the garment away from the perimeter. The at least one bead has a continuous path from the first region to the second region although the bead itself might be segmented. In a preferred embodiment the bra wing has a plurality of beads, the first bead conforming to the edge of the bra wing in the first region and traverses the interior of the garment in the second region. The trajectory of the bead in the second region does not conform to the contoured edge. The first bead is continuous and has a continuous unbroken trajectory from the first portion to the second portion. The second bead is a segmented or otherwise non-continuous bead that conforms to the edge trajectory in the first region and does not conform to the edge trajectory in the second region. The second bead also has a continuous unbroken trajectory from the first portion to the second portion.

The trajectory (i.e. the path) of the at least one uncured polymer bead is continuous from the first portion to the second portion even if the bra wing has stays or panels that cause the surface of the bra wing to be uneven. The continuous trajectory from the first portion to the second portion is advantageous for both fit and function. For purposes of a bra wing, smooth fit is critical since a bra is worn under clothing. For a variety of reasons the wearer prefers the presence of the bra to be discrete (i.e. not visually detectable or at least not obviously detectable). Therefore a bra wing that provides a conforming fit to the wearer is highly desirable.

As noted above, the coordinate surface is equipped with features that provide for precision placement of the fabric on its surface. One skilled in the art is aware of many different mechanisms that facilitate precision placement of objects on coordinate surfaces. As such, not all such mechanisms are described herein.

When depositing cured polymer (e.g. silicone) onto cotton fabric, particular problems are encountered. Certain embodiments of the present invention address these problems. Specifically, the system is configured to provide sufficient vacuum to draw the uncured silicone into the cotton fabric. The silicone is deposited onto the fabric just prior to the exposure of the fabric to the vacuum. The width of the silicone beads is selected to allow for silicone penetration into the fabric, ensuring that the silicone is anchored or binds to at least some of the interior fibers. In this regard, it is advantageous if the cotton fabric is a blend of cotton and synthetic fibers, since the twisted cotton fibers themselves can still be pulled apart despite the application of silicone thereon. Since synthetic fibers are a continuous fiber rather than a mass of individual twisted fibers, the synthetic fiber is more resistant to being pulled apart. This provides a garment that is highly resistant to silicone delamination.

### BRIEF DESCRIPTION OF THE DRAWINGS

The foregoing brief description, as well as further objects, features, and advantages of the present invention will be understood more completely from the following detailed description of presently preferred, but nonetheless illustrative embodiments in accordance with the present invention, with reference being had to the accompanying drawings in which:

FIGS. 1A-B are plan views of exemplary garment portions having a contoured perimeter produced using the method of the present invention.

FIG. 2 is a flow chart of an exemplary process flow according to the present invention.

FIG. 3 is a perspective view of one embodiment of the system of the present invention.

FIG. 4 is a detail view of a portion of the embodiment illustrated in FIG. 3.

FIG. 5 is a perspective side view of one embodiment of the system of the present invention.

FIGS. 6A and 6B are detail views of another portion of the embodiment illustrated in FIG. 3.

FIG. 7 is a bottom up view schematic of one embodiment of a dispensing head used in the present invention.

FIG. 8 is a top down plan view of a silicone deposition from the dispensing head illustrated in FIG. 7.

FIG. 9 is an exploded view of a dispensing head according to one embodiment of the present invention.

FIG. 10A-B are perspective views of another embodiment of a dispensing head for use in the present invention.

FIG. 11 is a top down view of the coordinate surface according to one embodiment of the present invention.

FIG. 12 is an illustration of a cut fabric piece according to one embodiment of the present invention.

FIGS. 13A-C illustrate other garment portions with silicone deposited thereon.

FIG. 14 is a top perspective detail view illustrating the vacuum port used to draw silicone into the fabric according to one embodiment.

FIG. 15 is a top perspective view illustrating one embodiment of the system of the present invention, a portion of which is illustrated in FIG. 14.

FIG. 16 is a perspective view of the heater section of the system illustrated in FIG. 15.

FIG. 17 is a perspective view of the underside of the heater section illustrated in FIG. 16.

### DETAILED DESCRIPTION

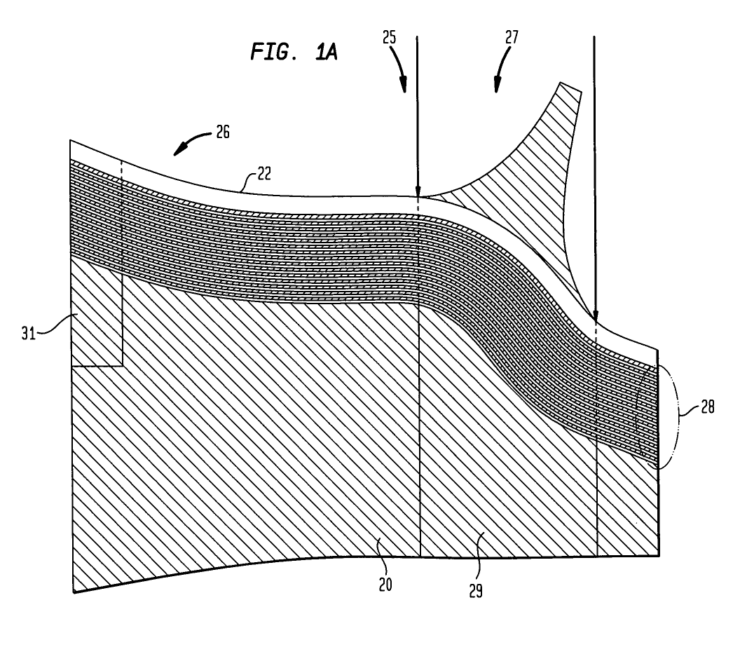

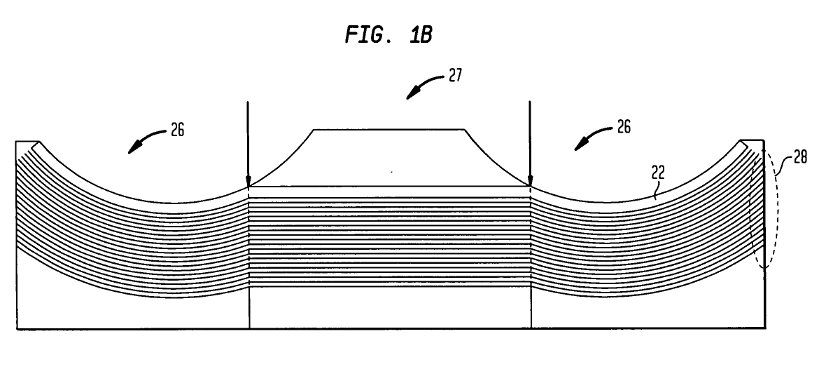

FIG. 1A shows a cut pattern piece 20 having a contoured edge 22. FIG. 1 is what is known as a bra wing. Although not shown in FIG. 1, the perimeter 22 includes a plurality of fibers having ends that terminate at the perimeter 22. On a microscopic scale, the free ends of the fibers in the edge region are loose, which makes the edge region subject to fraying or tearing when wearing or washing the piece 20. In order to bind the free ends of the fibers, a first bead of silicone material 26 is deposited at the edge region that terminates at the perimeter 22. The first bead of silicone material 26 preferably contacts and binds the fibers in the edge region of the pattern piece 20.

Note that, while this embodiment includes a bead of silicone that contacts the free ends of the fibers in the edge region, there is no requirement that the silicone bead be applied in precise alignment with perimeter of the fabric in order to achieve the objectives of this invention. In this regard the silicone may be deposited proximate to the adjacent to, near to or removed from the perimeter and still conform to the perimeter contour. Even removed from the perimeter, the silicone bead achieves the reduction or elimination of fraying without using conventional or bulky edge trim to finish the edge region of the fabric.

Note that the first bead of silicone 26 conforms to the contour of the perimeter 22. The contour is one example of what is referred to herein as a non-linear trajectory. In a multi-dimensional (e.g., x-y, x-y-z, etc.) space the non-linear trajectory represents as a trajectory (i.e. a path) which changes in a first dimension and a second dimension (e.g. a change in x and y). In the embodiments where a dispensing head is used, the dispensing head is also rotated to dispense the polymer in the correct direction as the dispensing head is moved in x and y space. The rotation of the dispensing head is referred to herein as dimension “r.” Up and down movement of the head is referred to as dimension “z.” Other degrees of freedom for depositing silicone on the fabric are achieved by starting and stopping the deposition of the silicone with respect to its placement on the fabric (i.e. the silicone does not need to be deposited in some continuous trajectory from a first end of the fabric to a second end).

The pattern piece also has a series of second silicone beads 28 deposited adjacent the first silicone bead 26. The second beads 28 are preferably thinner than the first bead 26 of silicone material. The series of second beads 28 preferably conform to the contour of perimeter 22 of fabric 20. In other embodiments, the second beads are in the interior region of the fabric and/or may follow a path that is curved, S-shaped, or discontinuous. As previously noted, it is advantageous if the second beads 28 are non-continuous or segmented. In one exemplary embodiment, the segments are silicone dots. The present invention provides a method and apparatus for depositing the continuous or non-continuous silicone beads in any configuration with precision. Non-continuous, in the context of the second beads 28, refers to a separation between silicone portions of the bead and is not a reference to its trajectory unless expressly so stated.

The bra wing 20 has a first portion 25 and a second portion 27. In the first portion 25 the continuous silicone bead 26 conforms to the perimeter 22 of the bra wing 20. In the second portion 27 the continuous silicone bead 26 does not conform to the perimeter but transitions into the interior region of the bra wing 20. The continuous silicone bead 26 exhibits a continuous, unbroken trajectory from the first portion 25 to the second portion 27. Likewise the non-continuous silicone beads 28 are removed from the perimeter 22 but conform to the contour of the perimeter 22 in the first portion 25. In the second portion, 27, the non-continuous silicone beads 28 do not conform to the contour of the perimeter 22. However, the non-continuous silicone beads 28 have a continuous trajectory (although the silicone beads 28 are themselves segmented) from the first portion 25 to the second portion 27.

In the illustrated embodiment, the bra wing 20 has a panel 29 or stay 31 in the second portion. This causes the surface of the bra wing 20 to be uneven. That is, the panel 29 or stay 31 adds to the thickness of bra wing 20. Although the thickness of the bra wing changes as the silicone beads 26, 28 transition up and over the stay 31 or panel 29, the trajectory of the first and second beads 26, 28 remains continuous. Again, the continuous trajectory is advantageous because it provides better fit and comfort to the wearer.

The cut fabric piece 20 can be made of any material. As such the cut fabric piece can be formed from natural fibers (e.g. cotton, wool), synthetic fibers (e.g. polyester, polyurethane, nylon, rayon) or blends of natural and synthetic fibers. As stated previously, the present invention finds use in manufacturing a variety of garments from the cut fabric pieces including, but not limited to, foundation garments and active wear. If the cut fabric piece is cotton or a synthetic/cotton blend, it is advantageous if the silicone is deposited under conditions that will cause the silicone to at least partially penetrate the fabric. Such conditions are described in detail below.

Another portion 26 of a bra is illustrated in FIG. 1B. In this embodiment, the cut fabric piece has contours in regions 26 to accommodate bra cups (not shown). There is a linear portion in region 27 interposed between the contoured portions 26. The silicone beads 28 conform to the contoured edge in portions 26 but not in portion 27. Similarly, the silicone bead at the perimeter 22 conforms to the perimeter in portion 26 but not in portion 27.

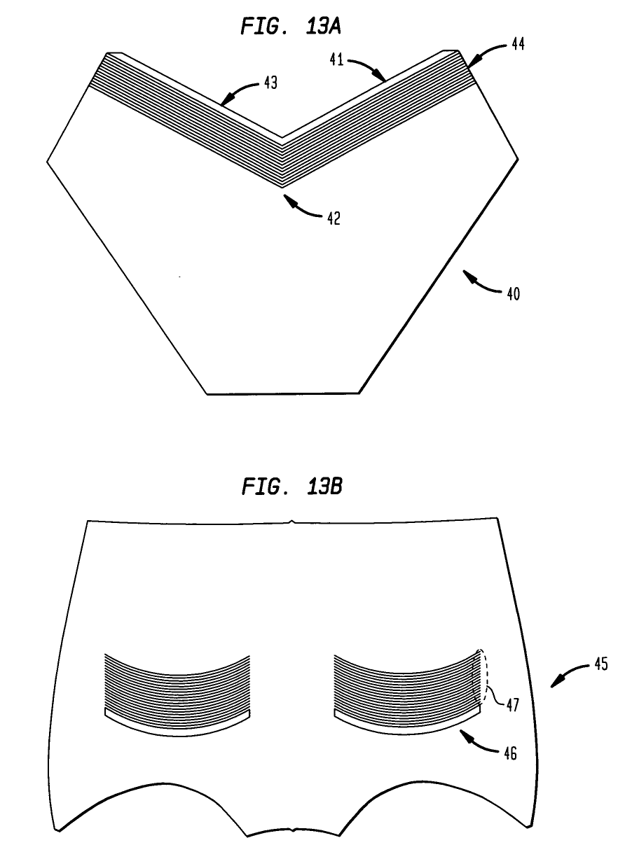

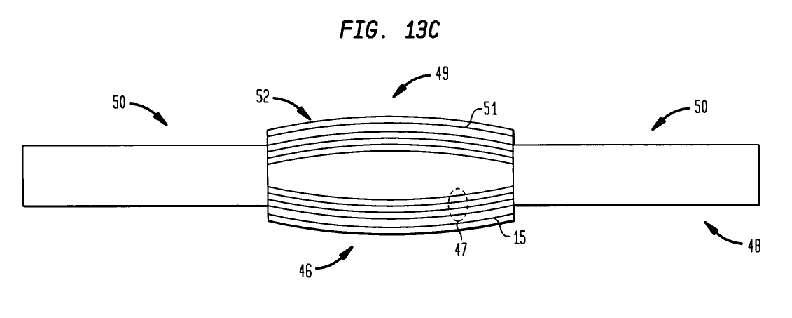

Another garment in to which the plurality of precisely placed continuous and non-continuous beads described herein provides particular advantage is any undergarment or shapewear garment with a contoured end shaped like a V. Such a garment 40 is illustrated in FIG. 13A (a portion of a garment with a neckline). The v-configuration 41 is particularly challenging when depositing a series of curable polymer beads because of the abrupt change in direction required by the notch 42. As illustrated in FIG. 13A, the garment has a first continuous bead 43 along the v-shaped contoured edge. The garment 40 also has a plurality of non-continuous curable polymer beads 44 on the inside of the garment (the garment is illustrated from the inside looking out). The non-continuous polymer beads 44 follow the contour defined by the v-shaped perimeter 41.

Other garments in which the silicone is deposited in discrete locations on the fabric are illustrated in FIGS. 13 B and 13C. Referring to FIG. 13 B, the back panel of a shapewear undergarment is illustrated. The back panel is configured to be incorporated into shapewear configured to shape the lower torso. A series of individual silicone beads 47 fix the garment to the buttocks of the wearer and impart a desirable shape and appearance. The silicone beads ensure that the garment stays in the desired location and does not shift. Note that the silicone bead 46, 47 configurations are completely decoupled from the perimeter contour. Note also that the beads themselves do not span two ends of the garment 45.

The garment illustrated in FIG. 13B provides a vast improvement over previous garments that had silicone deposited thereon. Specifically, the fact that the silicone bead is not required to span two ends of the garment provides complete freedom to where the silicone is placed on the garment. Such a garment could not be manufactured by prior art processes that did not allow for the silicone deposition to start and stop as the silicone is being deposited on the fabric. Such garments are advantageous because silicone is placed precisely where it is needed and is not required to be placed elsewhere.

The shoulder strap 48 illustrated in FIG. 13C is yet another example of a garment in which the customized placement of silicone that is not tied to traversing the fabric from end to opposing end. Specifically, silicone beads 47 are deposited on the wider portion 49 of the strap 48. The wider portion 49 rests on the shoulder of the wearer and the silicone serves to keep the strap in place on the wearer. Shoulder strap 48 also has narrower portions 50 which fix the shoulder portion to other portions of the garment (not shown). There is no silicone on these narrower portions 50. If the silicone beads 47 were to extend into the strap portions 50, the silicone would adversely affect the fastening of the strap portions 50 to the garment.

Although a silicone bead 51 is illustrated in FIG. 13C along the perimeter 52 of the shoulder portion 49 of the strap 48, the silicone bead along the perimeter is not required. Other conventional ways to finish the edges can be used in garments that have silicone placed as desired, without constraining the deposition to edge regions or edge configurations. However, it is advantageous to manufacture shapewear and other garments where a precise and conforming fit is desired with both an edge finished with a silicone bead and one or more beads placed in the interior region of the fabric panel to provide for superior fit and function.

It is exceptionally difficult to deposit the curable polymer on the garment in a precise V because of the need to start and stop the flow of the curable polymer as the dispensing head changes direction at the notch 42. The system and method described herein, in which the needle valve allows the flow of the curable polymer to start and stop virtually instantaneously, provides particular advantage. One of the difficulties of starting and stopping the silicone is that silicone icicles build up on the dispensing head. This can cause silicone to be placed in undesired locations on the fabric or in undesired amounts or configurations (i.e. a deposit that is thicker or wider than the bead). To avoid the adverse consequences of silicon icicles forming on the dispensing head, a stop sequence in which the pressure is turned off followed by the touching of the dispensing head to the fabric. It is advantageous if about a second elapses between when the pressure is turned off and the dispensing head contacts the fabric.

Additionally, the precision placement of the curable polymer by the system and apparatus described herein allows the continuous and non-continuous curable polymer beads to be placed in manner that the beads on one side of the notch 42 intersect with the beads on the other side of the notch 42 in the vicinity of the notch 42. This provides for a fit and comfort advantage to the wearer. Specifically, the notch fits around the wearer's midsection. The silicone conforming to the notched contour keeps the notch in position relative to the wearer's midsection, thereby reducing any bulging effects caused by the garment. Often the flesh around the midsection of the wearer does bulge around the waistband of an undergarment. The notch reduces or eliminates such bulges, which can be unsightly or cause the wearer to be unduly self-conscious. Unsightly bulges can be pronounced when the wearer is sitting. The silicone keeps the notched garment in place to avoid the garment from causing an undesirable appearance for the wearer.

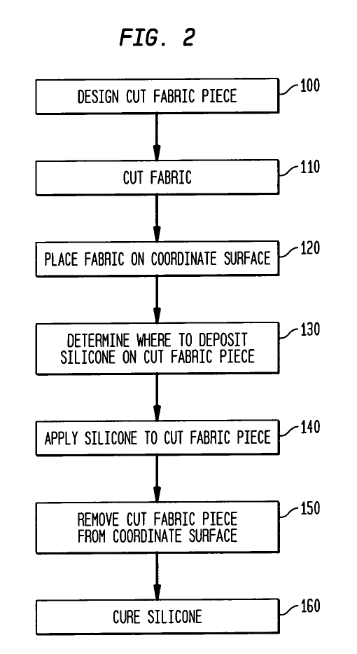

Referring to FIG. 2, there is a flow chart of one process flow of the present invention. Although the flow chart presents steps in a particular order, one skilled in the art will appreciate that the steps presented can be practiced in a different order.

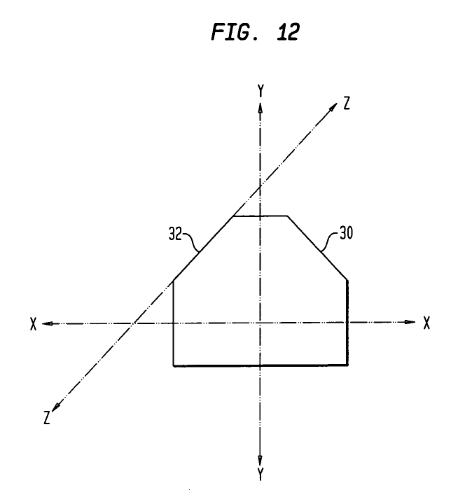

Referring to step 100, the cut fabric piece is designed. Designed, as used herein, encompasses numerous design concepts. One primary concept is the role played by the cut fabric piece in the finished garment. This dictates the configuration of the cut fabric piece as well as the placement of the curable polymer thereon. In the design step, the material of the cut fabric piece is also selected. While material selection is largely driven by garment design, one skilled in the art will appreciate that fabrics can be engineered to have different degrees of stretch in different directions. Such a fabric is illustrated in FIG. 12. The cut fabric piece 30 is more stretchable in a first axial direction designated Y than a second axial direction designated X. The cut pattern piece 30 has a first unfinished edge 32 that extends in a third axial direct designated Z that traverses or crosses the first axial direction Y and the second axial direction X. The direction of the unfinished edge 32 can be readily modified depending upon adjustability and fit requirements. Although the edges 32 are illustrated as the perimeter of the fabric 30, one skilled in the art will appreciate that the edge region of the fabric extends into the fabric interior. There are therefore many variables that must be considered when designing the fabric piece. While fabric design is an important step in garment fabrication, the present invention is not limited to any particular fabric materials or fabric characteristics.

Referring to step 110, the design fabric piece is cut. One skilled in the art is aware of many different methods for cutting the fabric piece into the desired configuration for the garment. Some of these methods are described in detail in the aforementioned U.S. Pat. No. 7,228,809 and U.S. patent application Ser. No. 11/811,171 and are not described in further detail herein. The present invention contemplates that the cut fabric piece will be cut using conventional methods, which includes both manual (e.g. scissor cutting) and automated techniques. Automated techniques include Gerber cutting, die cutting, sonic cutting, hydro cutting, laser cutting and combinations of these techniques.

Once the cut fabric piece has been designed and cut, it is placed on the coordinate surface according to step 120. The system, based upon inputs from the operator regarding fabric configuration and placement of the curable polymer (e.g. silicone) thereon, senses the location of the cut fabric piece in the coordinate space and determines, relative to the placed cut fabric piece, where to deposit silicone according to step 130.

In one embodiment, the placement of the silicone is determined algorithmically using discrete inputs from the operator. Exemplary inputs include, but are not limited to, cut fabric dimensions, fabric materials, fabric elasticity and the function of the silicone being deposited (i.e. finish edge, tread or both). The properties of the curable polymer itself are also considered. In this regard it is preferred if the flow rate at which the curable polymer is dispensed onto the cut fabric piece remains relatively constant for deposition on the cut fabric. Variations in flow rate can cause variations in the consistency of the curable polymer or, variations in the size of the multiple beads of curable polymer. These variations are typically not desired.

Once the location of the silicone on the cut fabric piece is selected, the silicone is applied to the cut fabric piece as set forth in step 140. One skilled in the art will appreciate that a number of different techniques can be used to apply the curable silicone. In one embodiment, an automated process is used to deposit the curable silicone. In this embodiment, microcontroller software (e.g. Win/CNC Software which is commercially available from Microsystems of Buckhannon Inc. of Buckhannon W. Va.) is programmed with the coordinates of the cut fabric piece relative to the coordinate space. The microcontroller is also programmed with the desired deposited trajectory of the curable silicone. The microcontroller cooperates with a positioning mechanism to position a dispenser for the curable silicone dispenser relative to the cut fabric piece. In order for the curable silicon to be deposited in the preferred non-linear trajectory, the dispensing head must not only be positioned in x-y space, but the dispensing head must be rotatable in its x-y position. Thus, the microcontroller and the positioning mechanism cooperated to position the dispensing head in x, y and r (rotation) space.

As such, the microcontroller controls the application of the curable silicone on the cut fabric piece. As described in detail herein, the cut fabric piece is placed in a coordinate space that corresponds to the programmed coordinates. This permits the controller to locate the cut fabric piece on the coordinate surface, which also functions as a supporting surface, apply the silicone on the specified location of the cut fabric piece and transfer the cut fabric piece to the curing station. The transfer of the cut fabric piece into and from the coordinate space can be either manual or automatic. The coordinate surface will be described in detail later in the context of the illustrative embodiments. The software is also used to control the thickness/configuration (e.g. bead size and spacing) of the curable silicone.

In a preferred embodiment, the coordinate surface has a disposable absorbent covering thereon. The disposable absorbent covering absorbs any excess curable silicone that is not deposited on the cut fabric piece. The disposable absorbent covering assists in allowing a clean break from the curable silicone deposited on the cut fabric piece and the excess deposited on the absorbent covering. As used herein, a clean break is a non-jagged break.

After the curable polymer is applied onto the cut fabric pieces and the cut fabric pieces are transferred from the coordinate surface, the disposable absorbent covering is removed along with the excess curable polymer deposited thereon.

Typically, the curable polymer is clear when cured and not visually detectable when placed at the edge of a garment. Treads (i.e., the segments of the non-continuous bead) formed according to the present invention are in the interior of the garment. Therefore it matters little whether the treads are transparent or opaque. In one optional embodiment, however, the curable polymer contains a dye so that the curable polymer at least somewhat matches the color of the cut fabric piece. Dyes or other additives suitable for coloring curable polymers are well known in the art and not described in detail herein. The color of the selected dye depends upon, for example, the color of the cut fabric piece and the degree of match between the curable polymer and the cut fabric piece that is sought (if any).

As previously noted, it is advantageous if the curable polymer is silicone-based. Curable silicone polymers are well known to one skilled in the art and are not described in detail herein. Silicones are used in a vast array of applications including lubricants, adhesives, coatings, paints, synthetic rubber, electrical insulation and prosthetic replacements for body parts. In one particularly preferred embodiment, the curable silicone is a compound made up of, by weight, approximately 10-30% silica and 60-90% vinylpolydimethylsiloxane.

The uncured polymer is deposited in liquid form at temperatures in the range of about 70° F. to about 90° F., and more preferably temperatures of about 78° F. to about 90° F. At these temperatures, the curable polymer has a sufficiently low viscosity to facilitate application onto the cut fabric piece. If the temperature significantly exceeds 90° F., then the bead of curable polymer is too thin. In this regard, it is advantageous if the curable polymer has some tackiness when applied to the cut fabric piece to provide for easier handling of the cut fabric piece prior to cure. If the temperature is less than 70° F., then the silicone is too thick and does not penetrate into the fabric in a manner that facilitates adhesion of the silicone to the fabric.

The curable polymer is applied using any suitable mechanism. However, in order to meet the objectives of targeted placement and speed, a multi-aperture dispensing head is preferred. The apertures are largely a matter of design choice and configured to provide a curable polymer bead of desired dimension. A slot-type nozzle is advantageous because it provides for targeted deposition of a bead of curable polymer.

After the curable silicone polymer is applied on the cut fabric piece, the cut fabric piece is removed (step 150) from the coordinate surface and conveyed to a curing station where it is subjected to curing conditions (step 160). The preferred curable polymer cures if exposed to a source of energy (e.g. heat, UV radiation). Curing conditions will vary depending upon the specific curable polymer that is used. If heat is used, the cure temperature must be below the heat tolerance temperature of the cut fabric piece. All fabrics have an associated heat set temperature. The heat set temperature is the temperature below which the fabric characteristics remain unchanged. Above this temperature, fabric characteristics (e.g. fabric dimensions) will changes. Since a change in fabric characteristics is not desired during cure, the cure temperature is maintained below the heat set temperature of the fabric. It is advantageous if the cure temperature does not exceed about 340° F. In certain preferred embodiments, the silicone is heated to approximately 260-280° F. In more preferred embodiments, the silicone is heated to approximately 265-275° F.

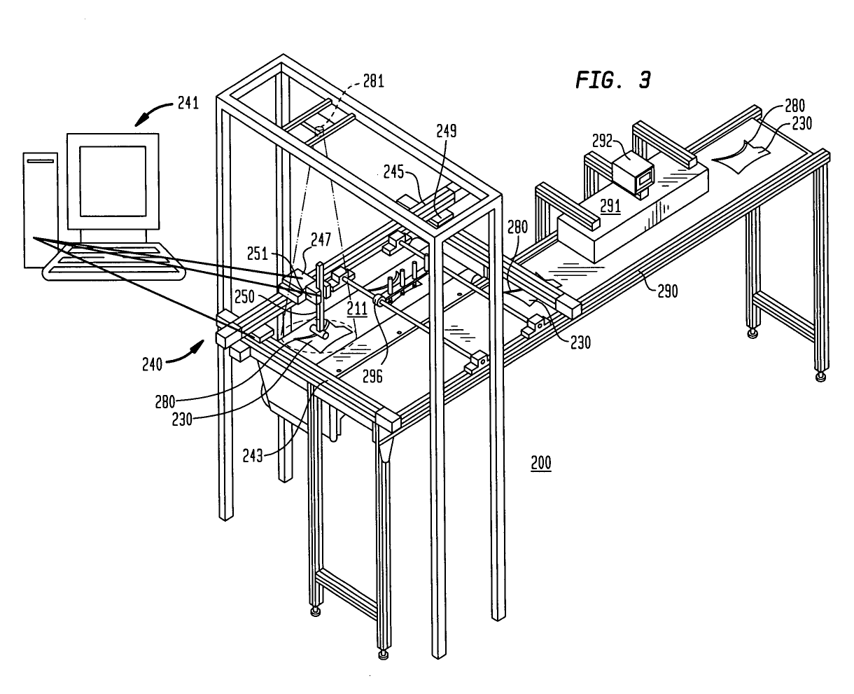

Referring now to FIG. 3, there is illustrated a system for applying a curable polymer to the cut fabric piece according to one embodiment of the present invention. According to the embodiment illustrated in FIG. 3, the system 200 has a coordinate surface 211. The coordinate surface 211 supports cut fabric pieces 230.

The system 200 is also equipped with a motorized positioner 240. This motorized positioner has two slides, one slide 243 for movement along the “y” axis and another slide 245 for movement along the “x” axis. The motorized positioner 240 also has servo or stepper motors to allow for movement of curable polymer dispensing head 250. Servo motors are preferred for their more precise movement control. Motor 249 is provided to move the dispensing head along the “y” axis. Motorized positioner 240 also has another motor 247 which moves the curable polymer dispensing head 250 along the “x” axis. Yet a third motor 251 is provided to rotate dispensing head 250. The third motor thereby orients dispensing head in the “r” direction. Although only one dispensing head is illustrated in FIG. 3, the invention contemplates a system in which multiple dispensing heads are used. The system is equipped with a controller 241. Controller 241 is programmed with the software needed to control the motors 247, 249 and 251 in response to coordinates in the software. In this regard the software has coordinates that correspond to the coordinate surface 211. In one embodiment, described in further detail below, a camera 281 transmits information about the location of the cut fabric piece(s) on coordinate surface 211. The controller 241 receives this location information. Based upon this location information and the information regarding the size and configuration of the cut fabric pieces, the controller 241 determines the movement trajectory of the dispenser 250. The controller then sends signals to motors 247, 249 and 251 to control the movement of the dispensing head to deposit the curable polymer in the desired trajectory.

The curable polymer dispensing head 250 is moved to dispense curable polymer 280 on cut fabric pieces 230. As illustrated in FIG. 3, motor 247 moves the curable polymer dispensing head 250 along linear slide “x” axis 240. Meanwhile, motor 249 moves the curable polymer dispensing head 250 along linear slide “y” axis 243 and motor 251 rotates dispensing head 250 to provide the desired “r” direction. This movement allows the curable polymer dispensing head 250 to be positioned at virtually any location and any orientation above surface 211. Although only one curable polymer dispensing head is illustrated in the Figures, applicants contemplate embodiments in which multiple dispensing heads are used. For example, if three cut fabric pieces are disposed on surface 211 at one time, an array of three dispensing heads is contemplated. In this embodiment curable polymer can be dispensed onto multiple cut fabric pieces simultaneously. Such an arrangement speeds the process along, rather than using a single dispensing head to dispense curable polymer sequentially on each cut fabric piece.

The system 200 is also equipped with a conveyor 290 for moving the cut fabric pieces 230 from the coordinate surface 211 to the curing station 291. The curing system 291 is illustrated schematically. A curing station will be designed based upon the requisite curing conditions (e.g. temperature, dwell time). Once skilled in the art will be able to design a curing station for the curing conditions contemplated for the particular system.

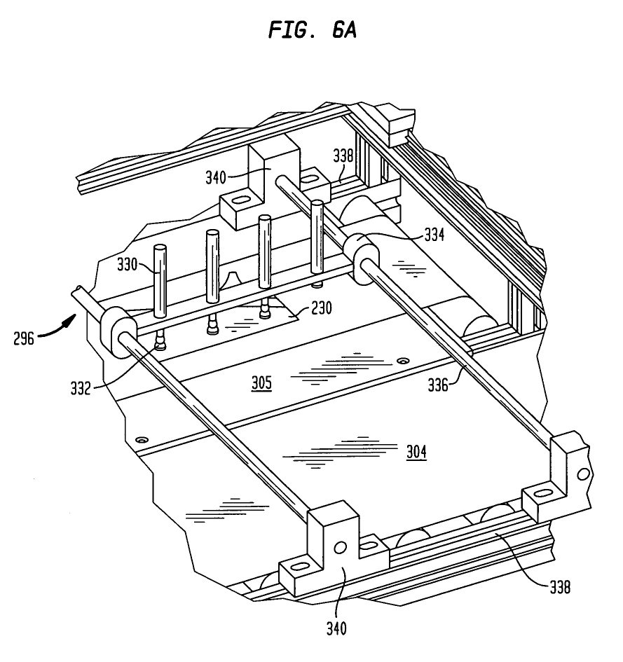

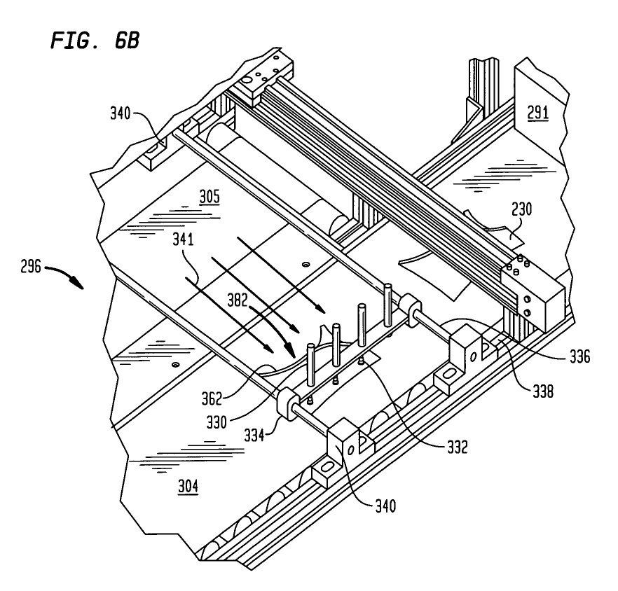

In the illustrated embodiment, an operator unloads the cut fabric pieces from the conveyor 290 onto coordinate surface 211. After the cured polymer is deposited on the cut fabric pieces 230, the operator loads the cut fabric pieces 230 back onto the conveyer 290. The conveyor 290 then introduces the cut fabric pieces 230 into the curing station 291. Although manual loading and unloading is contemplated, the embodiment in FIG. 3 depicts an automated system 296 for loading the cut fabric pieces onto and unloading the cut fabric pieces from the coordinate surface 211 which is described in further detail in FIG. 6A-6B. One skilled in the art can design such an automated system for so moving the cut fabric pieces on and off the conveyor.

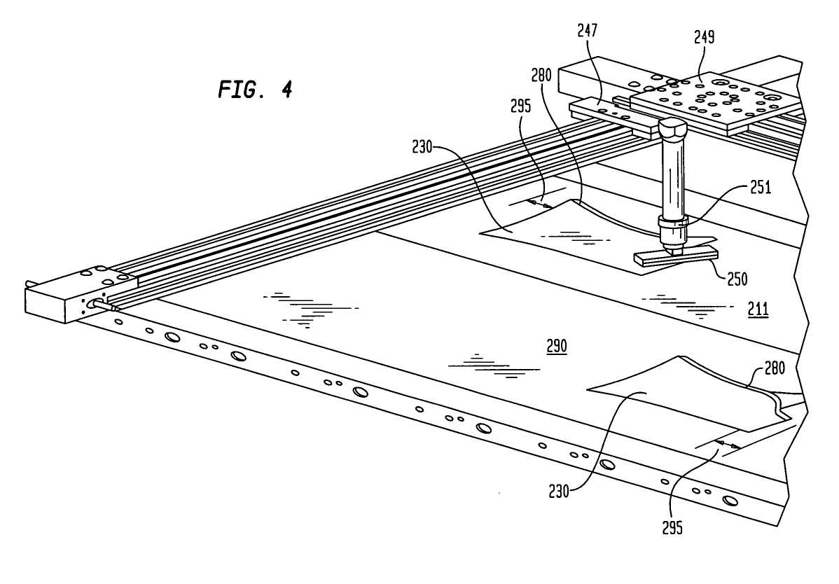

Referring to the detail view in FIG. 4, curable polymer 280 is dispensed along the perimeter of the cut fabric piece 230. The curable polymer is also dispensed as a discrete sequence of beads (not shown). In this regard, there is a bit of a delay between the time that the dispensing head begins dispensing the curable polymer and the time a bead of the desired uniformity is dispensed. Therefore, in one embodiment, there is programmed into the software a buffer zone so that dispensing of the curable polymer from the dispensing head commences prior to the dispensing head being positioned directly over the cut fabric piece. The distance from the position where dispensing commences and the edge of the cut fabric piece is distance 295 in FIG. 4. In embodiments where the nozzle response is immediate, the buffer zone is not required.

Furthermore, as the dispensing head 250 rotates to deposit a bead of silicone 280 in a manner that conforms to the curved edge of fabric 230, the rate at which the silicone is dispensed is adjusted to ensure that the width and thickness of the silicone bead is approximately constant. The silicone deposition rate is adjusted by any conventional mechanism (valving, pressure control, etc.) In preferred embodiment, the curve is gradual (i.e. a change in both the x and y directions). For example, confronted with a fabric having a ninety degree perimeter, it is more difficult for the system to provide a uniform bead over an abrupt ninety degree turn than a gradual curve in the fabric perimeter.

As previously noted, silicone icicles can form on the dispensing head 250 when the silicone flow is stopped at the end of a bead. In order to avoid icicle formation (which has the adverse effects previously described) the dispensing head 250 is brought into contact with the fabric within about a second less after the pressure for silicone flow out of the dispensing head 250 is turned off. In this embodiment, the dispensing head must be traveling at the same rate of speed as the conveyor belt 211 and in the same direction. Thus, the system is equipped with a controller that will adjust the speed of the dispensing head to match the speed and direction of the dispensing head prior to contacting the dispensing head to the fabric.

The above sequence can be reversed prior to dispensing the silicone bead. That is, the dispensing head is placed into contact with the fabric 230 prior to the commencement of the flow of silicone from the dispensing head. After contact, the pressure is switched on and the dispensing head 280 is removed from contact with the fabric. As in the stop sequence, the dispensing head 250 is moving at the same speed and in the same direction as the conveyor when in contact with the fabric 230.

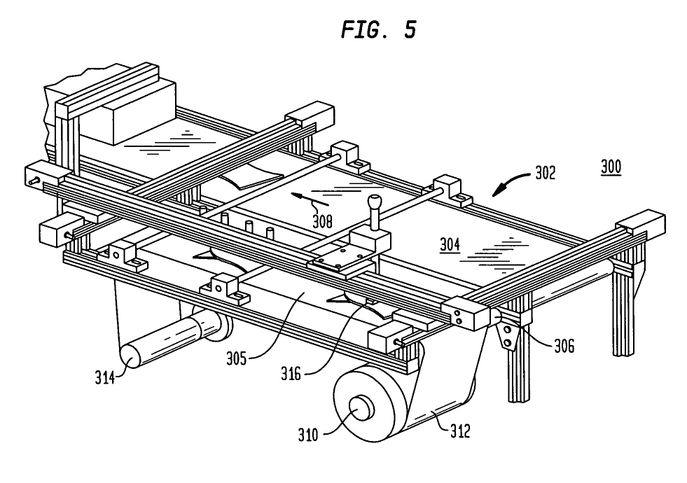

FIG. 5 is a perspective side view of an embodiment of the present invention. The system 300 includes a conveyor 302 having a belt 304 that is movable over rollers 306. The belt 304 moves over the rollers 306 in the direction indicated by arrow 308. The invention contemplates the deposition of some uncured polymer on the coordinate surface 305 in addition to the cut fabric piece. Since the bead of uncured polymer extends from the cut fabric piece, some uncured polymer remains on the coordinate surface after the cut fabric piece is removed therefrom. In a preferred embodiment, the separation of uncured polymer on the cut fabric piece from the uncured polymer on that remains on the coordinate surface is clean. In the context of the present invention a clean separation is a non-jagged edge (i.e. an edge without stringers or “icicles” of uncured polymer). In one embodiment, the use of absorbent paper (e.g. toilet paper) on the coordinate surface allows for a smooth edge for the uncured polymer when the cut fabric piece is removed from the coordinate surface.

In this regard, the system includes a paper storage roller 310 from which an absorbent material such as paper 312 is unwound. The absorbent paper 312 is guided into engagement with the coordinate surface 305 so that it is positioned over a top surface of the conveyor belt before a cut pattern piece is positioned on the conveyor belt. The system 300 also includes a second roller 314 that collects the absorbent paper at a point located downstream from the first roller 310. The system also includes a dispensing head 316 that applies silicone material over a cut pattern piece placed atop coordinate surface 305.

Referring to FIG. 6A, the system also includes an extender subassembly 296 that pushes the cut fabric piece 230 from the conveyor belt 304 onto the absorbent paper 312 and also pulls the cut pattern piece off the absorbent paper 312 after the silicone material has been deposited atop the fabric and places it back on conveyor 304. FIGS. 6A and 6B depict a transfer sequence from coordinated surface 305 to conveyor 304. Specifically, air cylinders 330 are used to engage vacuum cups 332 with cut fabric piece 230 by actuating suction cups 332 downward. Similarly, vacuum cups 332 are removed from engagement with fabric piece 230 by retracting vacuum cups 332 from this engagement. Air cylinders 330 and vacuum cups 332 form slidable transfer assembly 334. Slidable transfer assembly 334 is mounted on rails 336 that form part of an air actuated linear slide. Slidable transfer assembly 334 slides along these rails to transfer 230 back and forth from coordinate surface 305 to conveyor 304. The extender subassembly 296 is mounted on tracks 338. Brackets 340 disposed at the ends of rails 336 allow subassembly 296 to slide into position for transferring cut fabric pieces from conveyor 304 to coordinate surface 305 (not shown) and back again as illustrated in 6B. In FIG. 6B the cut fabric piece 230 is transferred from a first position on coordinate surface 305 (FIG. 6A) to a second position on conveyor 304. To achieve transfer, air cylinders 330 are deployed in a manner that causes suction cups 332 to engage with cut fabric piece 230. As slidable transfer assembly 334 moves along rails 336 from the first position on coordinate surface 305 to the second position on conveyor 304, cut fabric piece 230 moves along with it. This movement is illustrated by arrows 341. After reaching the second position, air cylinders 330 retract vacuum cups 332 from engagement with cut fabric piece 230. Upon release, cut fabric piece proceeds with conveyor 304 to the curing station 291.

System 296 also includes a curing station 291 having one or more heating coils (no shown) for heating the silicone applied to the fabric. During the heating process, the heat cures the silicone to permanently bind the silicone to the fabric. The system also includes one or more temperature sensors 292 (FIG. 3) provided in thermal communication with the top surface of the conveyor belt 304 so as to monitor the surface temperature of the conveyor belt.

As previously noted, the coordinate surface 305 is covered with absorbent paper 312. As the piece 230 is pulled off of the paper 312, the first silicone bead 362 at the edge 382 is broken from its engagement with the paper 312 to provide a smooth edge of silicone at the outer edge 382 of the pattern piece 230. Once the piece has been pulled off the paper 312, the pattern piece 230 is moved downstream along conveyor 304 to a curing stage 291. At the curing stage 291, the deposited silicone material is cured using heat. The curing stage has a heater (not shown) having heating coils (also not shown) that produce heat. The curing station is a function of dwell time (the amount of time that the curable polymer must be exposed to heat in order to cure). Dwell time is a function of many factors, including the amount of heat that is required to cure the curable polymer and the conveyor rate. As such, the number of heating stations and the extent of the heating stations are selected to provide the system with sufficient flexibility to provide a wide range of dwell times to meet processing requirements. The belt speed and the temperature can be adjusted as well to accommodate dwell time requirements to cure a particular polymer. In a preferred embodiment, the heating stage may include six (6) heating stations, each heating station having one or more heating elements. In one particular preferred embodiment, the heating elements are set in the range of about 500° F. to about 600° F. so that the surface temperature of the conveyor 304 is between 260° F. and 275° F. In highly preferred embodiments, the surface temperature should be about 268° F.-272° F.

The temperature sensor 292 has a temperature controller that may change the temperatures of the heating elements depending on ambient conditions. For example, in warmer ambient temperatures, the heating elements may be operated at lower temperatures than would be required under cooler ambient conditions. In certain preferred embodiments, the pattern piece and the silicone deposited on the piece are preferably cured for approximately 30 second to two minutes and more preferably about one minute.

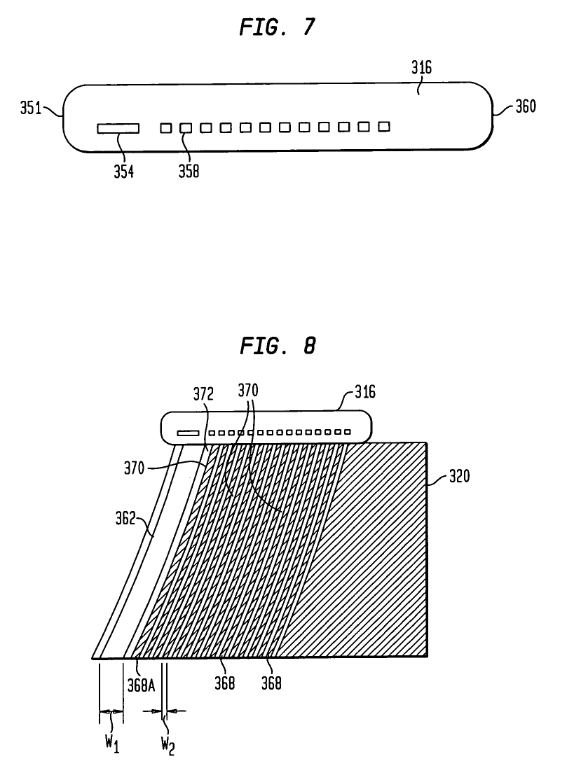

FIG. 7 illustrates a dispenser 316 for silicone, in accordance with certain preferred embodiments of the present invention. A series of openings 358 are provided at the bottom of the dispenser 316. The openings include an elongated opening 354 adjacent the first end 356 of the dispenser and a series of smaller openings 358 that extend between elongated opening 354 and a second end 360 of the dispenser 316. In operation, high pressure is provided inside the dispenser to dispense the silicone material through the openings 354, 358. In the illustrated embodiment, the openings 354, 358 are arranged along a straight line that extends between the first end 356 and the second end 360 of the dispenser 316. In other embodiments, the openings are arranged in a curve or other non-linear arrangement to deposit silicone beads in the desired pattern.

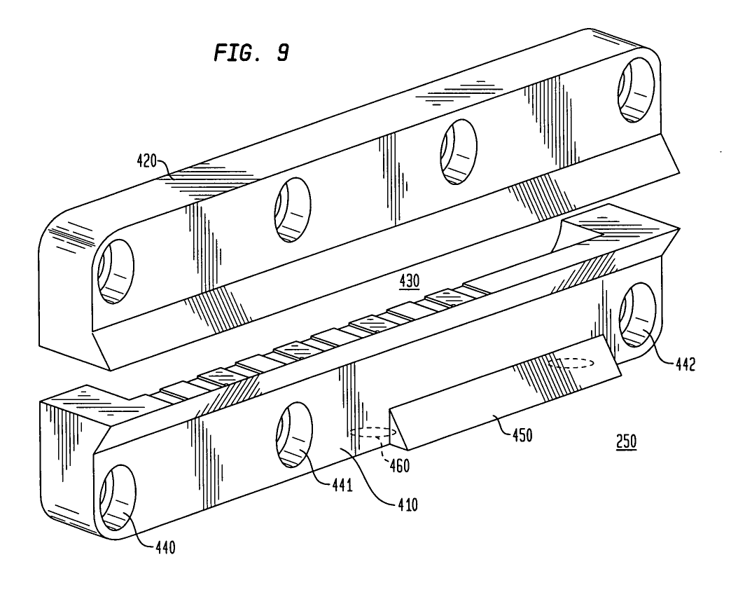

FIG. 8 shows the dispenser 316 depositing silicone onto a cut pattern piece 320. The silicone is dispensed in a pattern that includes thicker first silicone bead 362 deposited near the perimeter of the cut pattern piece in the edge region and a series of smaller second silicone beads 368 that are deposited inwardly from the edge region (i.e. the interior region). The second beads 368 are spaced from one another. As shown in FIG. 8, the first silicone bead 362 has a width W1 that is substantially greater than the width W2 of the second silicone beads 368. In addition, the second silicone beads are spaced from one other so that gaps 370 are present between the second silicone beads. Another gap 372 is present between first silicone bead and a first one of the second silicone beads 368A. Although the first silicone bead is illustrated as adjacent the fabric perimeter, it is contemplated that the first silicone bead can be adjacent, near or proximate the perimeter. The region of the fabric on which the silicone bead 362 is deposited is the edge region of the fabric, because, in certain embodiments the silicone bead 362 finishes the edge of the fabric. In this regard, the width of the silicone bead is not required to be coextensive with the edge region. That is, the edge region can be wider than that silicone bead 362 and the silicone bead 362 can be somewhat removed from the fabric perimeter and still be in the edge region. Referring to FIG. 9, additional details of the dispensing head 316 is illustrated. Specifically, dispensing head 316 has a front portion 410 and a back portion 420 that together define a cavity 430. The cavity receives the curable polymer (not shown) which is dispensed from the dispensing head 316 through on or more apertures at the base of the cavity 430. The flow of the curable polymer through these apertures is controlled by valves in the dispensing head.

FIG. 8 shows the dispenser head 316 as the dispenser deposits silicone beads 362, 368 over a top surface of pattern piece 320. As previously noted in the description of FIGS. 3-5, the silicone is deposited as the conveyor belt 304 moves fabric 230 in a direction indicated by arrow 308. When the pattern piece 230 is placed beneath the dispensing head 316, the silicone material 262, 268 is deposited onto the top surface of the pattern piece 230.

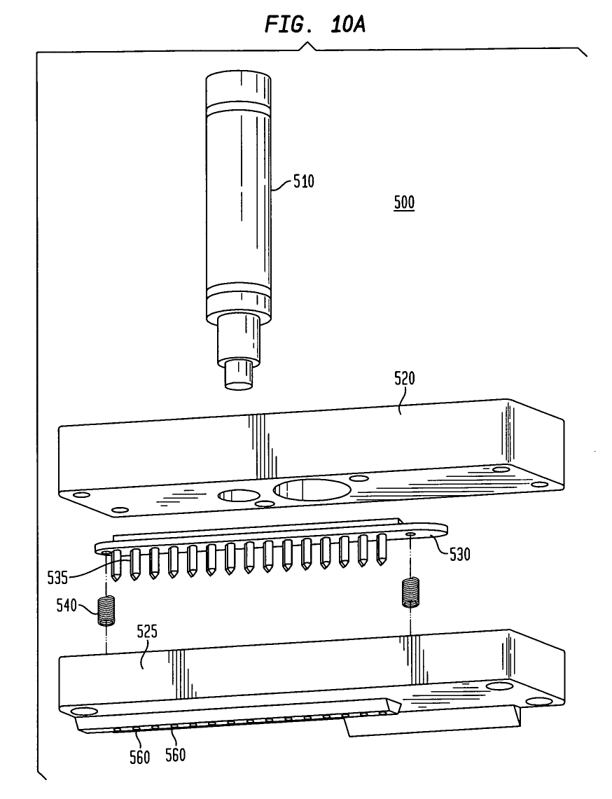

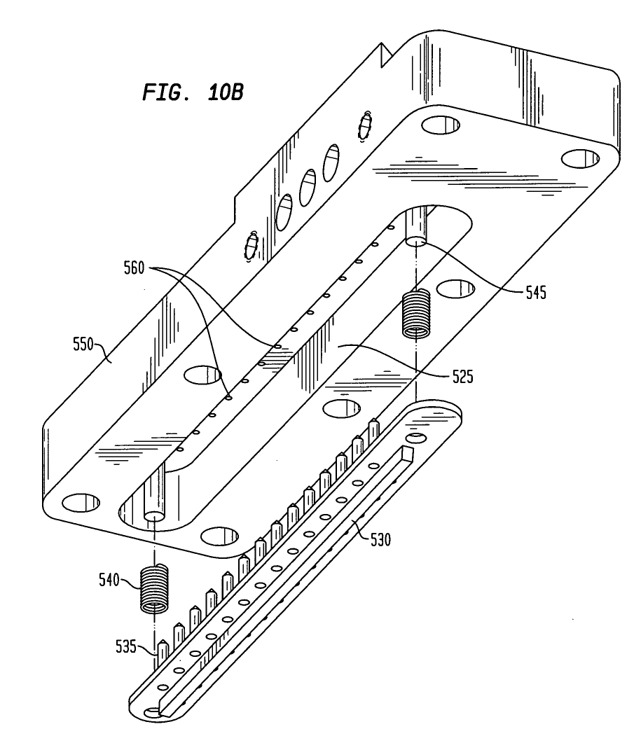

In the embodiment illustrated in FIGS. 10A and 10B, the dispensing head is equipped with needle valves to regulate the flow of the curable polymer therefrom. Referring to FIG. 10A, the valve 500 is illustrated as having an air cylinder 510 that will drive the valve 500 open and closed. The valve has a top head 520 and a bottom head 550. Top 520 and bottom 550 heads, when assembled, define a cavity 525. In the cavity is disposed needle plate 530. Needle plate 530 has a plurality of projections 535. These projections are sized to block adhesive outlet apertures 560 and the bottom of the bottom head 550 when the projections 535 are extended into the outlet apertures 560. Needle valve plate is actuated by air cylinder 510. Specifically, when actuated, air cylinder exerts force on needle plate 530 which force is sufficient to counteract the counter force from springs 540. As noted above, controller 241 controls the opening and closing of the valves, in addition to the position of the dispensing head to control depositing the curable polymer on the cut fabric pieces.

FIG. 10B is a perspective detail of the bottom head 550, illustrating the cavity, 525 which receives the uncured polymer. Needle plate 530 fits within cavity 525 and is movably connected to the bottom head 550 by posts 545. Tension mounting is provided by springs 540 also disposed on posts 545 and interposed between the bottom of cavity 525 and needle plate 530. Needle plate 530 has a plurality of projections 535 sized to completely block outlet apertures 560 also disposed at the bottom of cavity 525 in bottom head 550 when needle plate 530 is moved forward such that projections 535 enter outlet apertures 560. As noted above, springs 540 provide a counter force that moves needle plate 530 away from the bottom of the cavity 525 when the valve 500 is in the open position. The force of the springs 540 is overcome by the actuator 510 to move the plurality of projections 535 into contact with the outlet apertures 560, thereby blocking the apertures and placing the valve in its off position. The number of projections 535 corresponds with the number of outlet apertures 560.

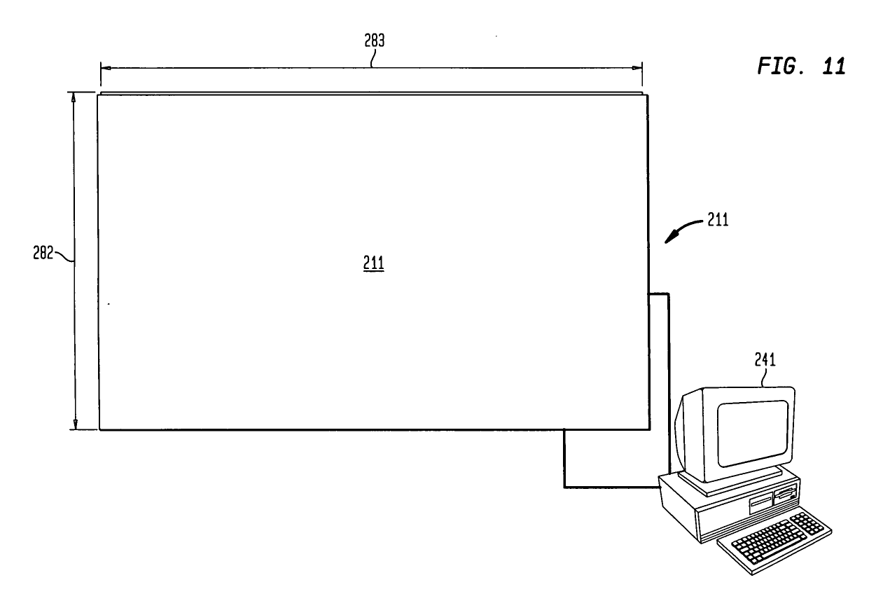

FIG. 11 illustrates the coordinate surface 211 with x axis and y axis designated. The coordinate surface is equipped with laser sensors (not shown) that sense the location of the cut fabric piece 230 on the coordinate surface 211. The sensors communicate with the controller, illustrated as CPU 241. The coordinates of the cut fabric piece sensed by the laser(s) are communicated to CPU 241. CPU 241 uses the coordinates and the pre-programmed information regarding the configuration of the cut fabric pieces and the trajectory of the uncured polymer to be deposited thereon. As previously stated, the algorithm also includes a buffer zone which allows for beginning to dispense the uncured polymer in a buffer zone that both precedes and follows the deposition of the bead of uncured polymer directly on the cut fabric piece if required. In the embodiments of the present invention that utilize a valve with instantaneous actuation, such as the pneumatic needle valve described in FIGS. 10A and 10B, this buffer zone is not required.

In another embodiment of the present invention, silicone is deposited on a cotton fabric. It is more difficult to deposit silicone onto cotton fabric than on other fabrics formed of synthetic fibers. Although applicants do not wish to be held to a particular theory, applicants believe that this difficulty results from the difference between cotton fibers, which are an aggregation of individual fibers twisted together, and synthetic fibers, which tend to be a continuous unitary fiber unlike a cotton fiber. The cotton fibers have a greater tendency to pull apart compared to synthetic fibers. In the context of the present invention, where silicone is deposited on the fabric, the silicone has a greater tendency to delaminate from the cotton fibers, which have a greater tendency to pull apart than the synthetic fibers. Because of the differences between cotton fibers and synthetic fibers, certain modifications to the embodiments described above are contemplated. These embodiments contemplate depositing silicon on fabrics that contain at least some cotton fibers in addition to synthetic fibers (i.e. synthetic/cotton blends). Cotton fabrics, as used herein, include 100% cotton fabrics and synthetic/cotton blends. As described herein, use of a synthetic/cotton blends is advantageous because the silicone has better adhesion to the blend than to the 100% cotton fiber fabric.

In order to achieve the desired degree of penetration into the fabric fibers, the dispensing head is configured to provide wider interior beads of silicone than in other applications. The width of the bead on the edge region of the fabric is unaffected. The wider silicone beads provide a sufficient amount of silicone to form around the core fibers of the fabric (in a synthetic/cotton blend, the core fibers are typically synthetic) thereby facilitating bonding of the silicone to the fibers. Smaller beads tend not to penetrate into the fabric, and therefore do not anchor in the fabric to the same extent.

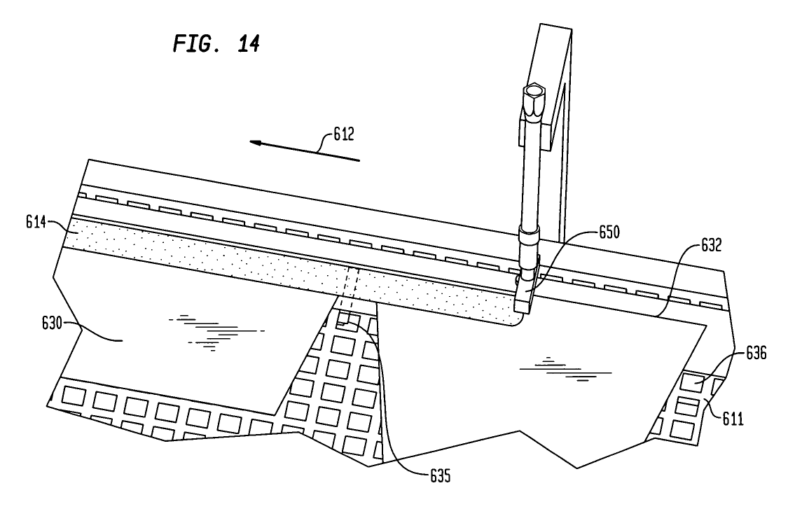

In order to facilitate the penetration of the silicone into the fabric, vacuum is used as a driving force. Referring to FIG. 14 conveyor 611 has a web mesh. In this embodiment, the dispensing head is fixed in the travel direction of the conveyor, illustrated by arrow 612. Although the bead 680 is illustrated as placed along a linear edge 632 of the fabric 630, deposition along a curved edge is contemplated according to the previous embodiments.

The conveyor 611 is a mesh fabric to allow for a vacuum force to be applied to the underside of fabric 630. The present invention contemplates a two tier vacuum system. The first tier is illustrated by larger aperture 636. These larger apertures are configured to provide sufficient vacuum force to keep the fabric 630 flat on the conveyor. The apertures 636 are spaced so that the fabric 630 does not substantially curl as it moves along with the conveyor. Cotton fabric has a particular tendency to curl, and the vacuum is particularly advantageous when the fabric 630 is cotton.

The second tier of vacuum is illustrated by smaller aperture 635. This aperture is smaller and therefore draws a vacuum with more force than the vacuum through aperture 636. The purpose of this aperture is to draw the silicone 614 into the fabric 630 after it has been deposited as a bead thereon. Note that the dimensions of the aperture 635 correspond to the width of the silicone bead. While the force of the vacuum is largely a matter of design choice, it advantageous if the vacuum causes some spread of the individual fibers in the fabric 630. This spread will facilitate the penetration of the silicone into the web of the fabric.

The aperture 635 (the portion beneath the silicone bead 614 is shown in phantom) is placed immediately following the dispensing head 650. This ensures that the silicone is in a substantially uncured state as the vacuum is applied through aperture 635 to draw the silicone into the fabric 630. In this regard, the silicone is required to have a viscosity that will permit it to penetrate into the fabric 630. A very viscous silicone will not penetrate into the fabric 630. Depending upon silicone viscosity, heaters may be employed to heat the silicone prior to being dispensed to ensure that its viscosity is adequately low. The vacuum eliminates silicone “icicles” that might extend from the fabric, which are not desirable. The vacuum also reduces or even eliminates the need for the absorbent paper to take up the silicone that is not affixed to the fabric 630 and eliminates waste.

In this embodiment there is no requirement that the uncured silicone deposited on the fabric conform to the perimeter contour or be otherwise near to or adjacent the perimeter of the fabric. Other methods of silicone deposition, i.e. those methods described in commonly assigned U.S. Pat. No. 7,228,809 to Angelino et al. and U.S. patent application Ser. No. 11/811,171 to Welsch et al., the disclosure of both of which are incorporated by reference herein, are contemplated as suitable for depositing the silicone on cotton fabric as described in those references.

The amount of vacuum that is applied will depend upon a variety of factors, including the viscosity of the silicone (or other suitable curable material), the weave of the fabric, the density of the fabric, the ply of the fabric (i.e. one or more layers) and other such considerations. One skilled in the art is able to ascertain the specific vacuum conditions that are required to draw the silicone or other curable material into the fabric in the manner required by the present invention (i.e. to anchor the silicone on the fabric yet not draw the silicone completely through the fabric. Specific vacuum conditions are not described herein but are readily ascertained by one skilled in the art.

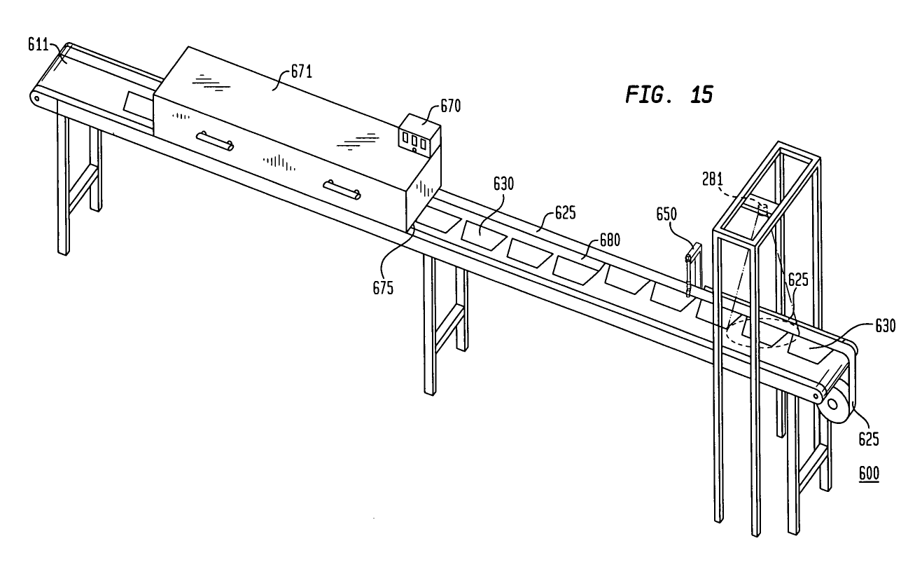

Referring to FIG. 15 the entire length of the system 600 is illustrated. The mesh conveyor belt 611 conveys the fabric 630 from right to left. Note that the portion of the fabric 630 onto which the silicone 680 is applied is placed over paper 625. Camera 626 ensures that the fabric is 630 is properly placed on the belt 611. This prevents excess silicone from being deposited on mesh conveyor belt 611. After the silicone bead 680 is dispensed from dispensing head 650 and deposited on fabric 630, the fabric 630 is conveyed past aperture 635, where the silicone is drawn into the fabric 630. After this, the fabric 630 with the silicone bead 680 thereon is conveyed into the curing station 670 through opening 675 in heater hood 671. Throughout this path, larger apertures spaced at intervals underlie the mesh conveyor belt 611 to keep the fabric flat.

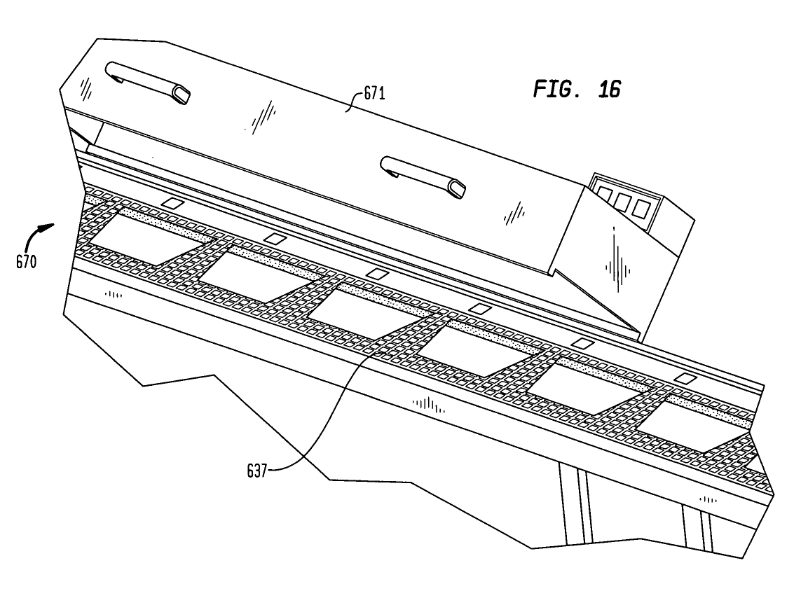

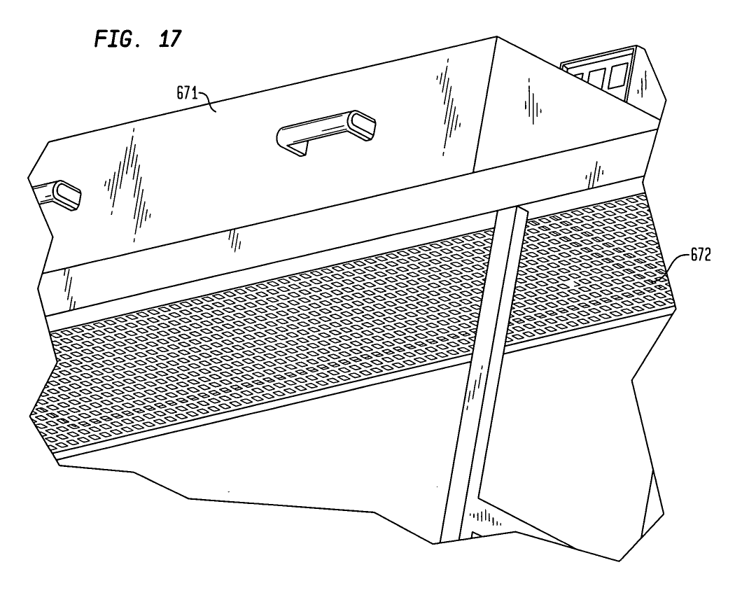

FIGS. 16 and 17 are top and bottom views of the curing section 670 illustrated in FIG. 15. In FIG. 16, the curing section 670 is illustrated with its hood 671 raised. The conveyor 611 with fabric 630 disposed thereon conveys the fabric 630 with silicone beads 680 thereon through the curing section 670. Aperture 637 is placed underneath the conveyor 611. Again this is so that vacuum may keep the fabric 630 flat in the curing section 670 during cure. FIG. 17 illustrates the chamber 672 underlying the curing section 670. The chamber cooperates with a blower (not shown) that draws the vacuum from the section of the conveyor 611 in the curing section. Vacuum in this section is particularly advantageous in those embodiments where the fabric 630 is cotton and cotton blend as these materials have a particular tendency to curl during cure.

In order to automate the process of moving and rotating the dispensing head, the system must be equipped with a controller that has access to a memory with stored instructions for the bead size and placement for a particular fabric configuration. If such a memory is provided, the process starts by scanning a barcode or inputting some other code that indicates fabric shape and materials characteristics to the controller. Alternatively, the fabric material and shape can be manually entered.

After the fabric information has been input into the system, the fabric piece is placed on the conveyor belt (either manually or automatically as described above). A sensor (e.g. an optical sensor) will detect the edge of the fabric to begin the sequence of depositing the silicone in the predetermined configuration for the identified fabric. In one embodiment a camera is provided to photograph the fabric piece and its orientation on the conveyor belt. The controller software will receive the image of the fabric and other input information (e.g. the barcode scan) and, from this information, will adapt the deposition of silicone to the actual orientation of the fabric on the conveyor.

Note that the system may require some additional lighting to ensure adequate contrast between the fabric and the background, in order for the system to accurately determine the orientation of the fabric on the conveyor.

There are many methods for teaching the system how a change in the speed or position of the dispensing head affects silicone deposition. For example, the dispensing head can be pushed manually from point to point for a particular fabric piece, and the information regarding that movement can be stored so that it can be subsequently duplicated. The controller software can also be programmed with cutting tolerances and fabric shrinkage and compensate for these and other variances in order to provide accurate silicone placement.

Although the invention herein has been described with reference to particular embodiments, it is to be understood that these embodiments are merely illustrative of the principles and applications of the present invention. It is therefore to be understood that numerous modifications, additions and substitutions may be made to the illustrative embodiments without departing from the scope and spirit of the invention or that other arrangements may be devised without departing from the spirit and scope of the present invention.

What is claimed:

1. A method for forming a garment comprising:
providing a cut fabric piece configured to be incorporated into a garment, the cut fabric piece having at least one contoured perimeter and having an edge region and an interior region;
placing the cut fabric piece in a coordinate space;
sensing the location of the cut fabric piece in the coordinate space;
communicating to a controller the location of the cut fabric piece in the coordinate space;
using the location information to control the movement of a curable polymer dispenser;
dispensing a curable polymer from the curable polymer dispenser onto the cut fabric piece in a non-linear configuration to form at least one bead of curable polymer thereon using the location information;
controlling the application of the curable polymer such that the bead of curable polymer substantially conforms to the contour of the perimeter; and
curing the curable polymer.

2. The method of claim 1 wherein the polymer bead is either continuous or non-continuous.

3. The method of claim 1 further comprising dispensing a plurality of beads of curable polymer, at least one bead being non-continuous.

4. The method of claim 3 wherein a first continuous polymer bead is deposited along the contoured edge of the cut fabric piece and a second non-continuous polymer bead is deposited remote from said contoured perimeter but in a pattern that substantially conforms to the contour of the cut fabric piece.

5. The method of claim 1 wherein the coordinate space is a planar surface in x and y space.

6. The method of claim 1 further comprising rotating the curable polymer while dispensing the curable polymer.

7. The method of claim 1 wherein the dispenser has a dispensing surface with at least one dispensing aperture therein, wherein the dispensing surface faces the cut fabric piece and the axis of rotation of the dispensing head is perpendicular to the dispensing surface.

8. The method of claim 1 further comprising transferring the cut fabric piece from a moving conveyor to the stationary coordinate surface prior to the step of dispensing the curable polymer.

9. The method of claim 1 further comprising transferring the cut fabric piece from the stationary coordinate surface to a moving conveyor after the step of dispensing the curable polymer but before the step of curing the curable polymer.

10. The method of claim 1 further comprising covering the coordinate surface with absorbent paper prior to placing the cur fabric piece in the coordinate space.

11. The method of claim 9 further comprising covering the coordinate surface with absorbent paper prior to placing the cur fabric piece in the coordinate space and removing the absorbent paper from the coordinate surface after transferring the cut fabric piece from the stationary coordinate surface to a moving conveyor.

12. A system for depositing a curable polymer onto a cut fabric piece in a non-linear configuration, the system comprising:
a coordinate surface for supporting and placing a cut fabric piece;
a dispenser comprising a rotatable dispensing head and a positioner for placing the dispensing head relative to the coordinate surface; and
a controller for controlling the positioner in response to a position sensor.

13. The system of claim 12 wherein the rotatable dispensing head has a dispensing surface with at least one dispensing aperture.

14. The system of claim 13 wherein the dispensing aperture is configured to dispense a bead of curable polymer.

15. The system of claim 14 wherein the dispensing head as a valve for controlling the flow of curable polymer from the dispensing head.

16. The system of claim 15 wherein the valve is a needle valve.

17. The system of claim 16 wherein the needle valve comprises at least one projection configured to close the dispensing aperture when brought into contact therewith.

18. The system of claim 17 wherein the dispensing head has a cavity with the needle valve disposed therein, the dispensing head having a cavity that communicates with the dispensing aperture, the dispensing cavity having the needle valve disposed therein.

19. The system of claim 18 further comprising an actuator.

20. The system of claim 19 wherein the actuator causes the projection to move into contact with and seal the aperture when the valve is actuated to the off position.

21. The system of claim 20 wherein the projection is away from the aperture when the valve is in the on position.

22. The system of claim 21 wherein the dispensing head has a plurality of dispensing apertures and a plurality of projections, and where the number of dispensing apertures is the same as the number of projections.

23. The system of claim 22 wherein the dispensing surface is perpendicular to the coordinate surface.

24. The system of claim 12 wherein the coordinate surface is adjacent a conveyor.

25. The system of claim 24 further comprising a linear slide for transferring the fabric piece between the conveyor and the coordinate surface.

26. The system of claim 25 wherein the linear slide further comprises a transfer head with an actuated conveyor.

27. The system of claim 26 wherein the actuated conveyor further comprises at least one vacuum head, an air actuator and a collar for moving the vacuum head from a first position on the coordinate surface to a second position on the conveyor along slide rails that bridge the first and second positions.

28. The system of claim 14 further comprising a curing station.

29. The system of claim 28 further comprising a conveyor adjacent the coordinate surface.

30. The system of claim 29 further comprising a transfer slide to move the cut fabric piece from the coordinate surface to the conveyor.

31. The system of claim 30 wherein the curing station cooperates with the conveyor to receive the cut fabric piece.

32. The system of claim 14 further comprising a sensor for sensing the position of the fabric panel within the coordinate space, wherein the sensor communicates with the controller for positioning the positioner in response to the sensed position of the fabric panel within the coordinate space.

33. The system of claim 32 wherein the sensor is a camera.

34. The system of claim 32 wherein the controller further comprises a memory for storing the dimensions of the fabric panel and for storing the placement of the curable polymer on the fabric panel, wherein the sensor provides the dimensions of the fabric panel to the controller and the controller compares the fabric panel dimensions as provided by the sensor with the dimensions of the fabric panel dimensions stored in memory and, if different, adjusts the placement of the curable polymer on the fabric panel in response to the difference.

35. The system of claim 32 wherein the controller compares the position of the fabric panel with a preprogrammed position and if a difference between the sensed position and the preprogrammed position exceeds a certain amount, the controller does not cause the dispenser to dispense curable polymer onto the fabric panel.

36. A fabric panel comprising:
a fabric substrate having at least one non-linear edge;
at least one bead of cured polymer with a trajectory, a first portion of the trajectory conforming to the non-linear perimeter of the fabric substrate and a second portion of the cured polymer bead not conforming to the non-linear perimeter wherein the trajectory is continuous from the first portion to the second portion.

37. The fabric panel of claim 36 comprising an edge region and an interior region wherein the at least one cured polymer bead is a continuous bead and is disposed on the edge region of the fabric substrate in the first portion of its trajectory and in the interior region in the second portion of its trajectory.

38. The fabric panel of claim 36 wherein the at least one cured polymer bead is a non-continuous bead and is disposed in the interior region of the fabric substrate in both the first portion and the second portion of its trajectory.

39. The fabric panel of claim 36 wherein the at least one cured polymer bead is a continuous bead and is disposed on the edge region of the fabric substrate in the first portion of its trajectory and on the interior region in the second portion of its trajectory.

40. The fabric panel of claim 37 further comprising a plurality of non-continuous beads.

41. The fabric panel of claim 37 wherein the fabric panel is configured as a bra wing and further comprising at least one of a panel or a stay, the trajectory of the at least one bead of cured polymer continuing up and over the at least one panel or stay.

42. The bra wing of claim 37 wherein the at least one bead of cured polymer is disposed on the at least one panel or stay in the second portion of its trajectory.

43. The fabric panel of claim 36 wherein the cured polymer is a silicone polymer.

44. The fabric panel of claim 36 wherein the fabric panel is configured as a shapewear panel with non-linear perimeter portions configured to join to bra cups.

45. A method for forming a garment comprising:
providing a fabric substrate having at least one non-linear perimeter portion;
dispensing a curable polymer from a curable polymer dispenser onto the fabric substrate in a continuous trajectory that has a first portion that conforms to the non-linear perimeter portion and a second portion that does not conform to the non-linear perimeter portion; and
curing the curable polymer.

46. The method of claim 45 wherein the fabric substrate is configured as a bra wing further comprises at least one panel or stay.

47. The method of claim 46 wherein the curable polymer is dispensed up and over the at least one panel or stay.

48. The method of claim 47 wherein the curable polymer is dispensed up and over the at least one panel or stay in the second portion of its trajectory.

49. The method of claim 45 wherein the curable polymer is a silicone polymer.

50. The method of claim 45 wherein the curable polymer is dispensed as a continuous bead onto an edge region of the fabric substrate in the first portion of its trajectory and dispensed as a continuous bead on an interior region of the fabric substrate removed from the fabric substrate in the second portion of its trajectory.

51. The method of claim 45 wherein the curable polymer is dispensed as a plurality of non-continuous beads on an interior region of the fabric substrate in both the first portion and the second portion of its trajectory.

52. The method of claim 45 wherein the curable polymer is dispensed as a plurality of curable polymer beads wherein at least one curable polymer bead is a continuous bead and is disposed on an edge region of the fabric substrate in the first portion of its trajectory and on an interior region in the second portion of its trajectory and additional curable polymer beads are a plurality of non-continuous beads that are dispensed on the interior region of the fabric substrate in both the first portion and the second portion of their trajectory plurality.

53. A garment comprising:
a fabric substrate having a perimeter with a notched contour; the contour having a first segment and a second segment together defining a notch;
at least one bead of cured polymer with a trajectory, a first portion of the trajectory conforming to the first segment of the notch the second portion of the cured polymer bead conforming to the second segment of the notch, the first portion and second portions meeting proximate the intersection of the first segment with the second segment.

54. The garment of claim 53 selected from the group consisting of an undergarment and a top garment with a v-neckline.

55. A method for forming a garment comprising:
providing a cut fabric piece comprising cotton configured to be incorporated into a garment, the cut fabric piece having a perimeter and having an edge region and an interior region;
dispensing a curable polymer from the curable polymer dispenser onto the cut fabric piece in a non-linear configuration to form at least one bead of curable polymer thereon using the location information;
applying a drawing force to draw the curable polymer into the cut fabric piece; and
curing the curable polymer.

56. The method of claim 55 further comprising flattening the cut fabric piece during the dispensing step.

57. The method of claim 55 further comprising flattening the cut fabric piece during the curing step.

58. A garment comprising:
a fabric panel comprising cotton with at least one bead of silicone deposited thereon, wherein at least some of the fibers embedded in the fabric panel are embedded in the silicone and at least some of the silicone is disposed on the surface of the fabric panel and not embedded therein.

59. The garment of claim 58 wherein the silicone bead is a plurality of beads in parallel arrangement on the surface of the fabric panel.

60. The garment of claim 59 wherein the plurality of silicone beads have a placement that does not traverse two ends of the fabric panel.

61. The garment of claim 59 wherein the plurality of the silicone beads traverse two ends of the fabric panel.

62. The garment of claim 61 wherein the plurality of silicone beads have a contour that at least partially conforms to a contour of at least one portion of the perimeter of the fabric panel.

63. The garment of claim 62 wherein the fabric panel has an edge region with a silicone bead thereon to provide a finished edge to the fabric panel.

64. A garment shoulder strap comprising:
a first portion that is configured to fit over the shoulder and a second portion that extends from the first portion to the garment to which the shoulder strap is affixed;
a plurality of silicone beads deposited on the first portion; and
no silicone deposited on the second portion.

65. A shapewear garment comprising:
at least one fabric panel incorporated into the garment to impart a desired shape to the wearer; and
a plurality of segmented silicone beads deposited on the interior of the fabric panel, the silicone beads placed to hold the garment in place on the wearer and wherein the trajectory of the silicone beads on the fabric panel is non-linear thereby at least partially conforming to the contour of the wearer.

66. A method of making a garment comprising:
depositing uncured silicone on a portion of a fabric comprising fibers, at least a portion of which are cotton fibers;
applying vacuum to the fabric to draw at least a portion of the uncured silicone into and at least partially surrounding a portion of the cotton fibers; and
curing the uncured silicone to provide a fabric having at least a portion of the cotton fibers encapsulated by silicone.
